(19) United States
(12) Patent Application Publication
(10) Pub. No.: US 2023/0010610 A1
(43) Pub. Date: Jan. 12, 2023

(54) COAXIAL CABLE AND CONNECTOR ASSEMBLIES AND METHODS OF ASSEMBLING SAME

(71) Applicant: CommScope Technologies LLC, Hickory, NC (US)

(72) Inventors: Jeffrey D. Paynter, Momence, IL (US); Joseph J. Baltikas, Homer Glen, IL (US); David J. Smentek, Lockport, IL (US)

(21) Appl. No.: 17/840,939

(22) Filed: Jun. 15, 2022

Related U.S. Application Data
(60) Provisional application No. 63/220,264, filed on Jul. 9, 2021.

(51) Int. Cl. H01R 24/56; H01R 9/05; H01B 11/18

(52) U.S. Cl. CPC H01R 24/564; H01R 9/0527; H01R 9/0518; H01B 11/1847; H01R 2103/00

(57) ABSTRACT

The present disclosure describes a coaxial cable-connector assembly. The coaxial cable-connector assembly including a coaxial cable, a coaxial connector, and a polymeric sleeve. The outer connector body is swaged or crimped onto the polymeric sleeve. An end of a corrugated outer conductor of the coaxial cable is flared radially outwardly to form a flared end that secures the polymeric sleeve onto the coaxial cable. The polymeric sleeve separates the corrugated outer conductor of the coaxial cable from the outer conductor body of the coaxial connector to prevent direct radial electrical connection therebetween and the polymeric sleeve axially forces the flared end of the outer conductor of the coaxial cable in contact with a shoulder of the outer connector body of the coaxial connector. Additional coaxial cable-connector assemblies and related methods of assembling the same are described herein.

### RELATED APPLICATION(S)

The present application claims priority to and the benefit of U.S. Provisional Application Ser. No. 63/220,264, filed Jul. 9, 2021, the disclosure of which is hereby incorporated herein in its entirety.

### FIELD

The present invention relates generally to electrical cable connectors, and more particularly to coaxial connectors for electrical cables.

### BACKGROUND

Coaxial cables are commonly utilized in RF communications systems. A typical coaxial cable includes an inner conductor, an outer conductor, a dielectric layer that separates the inner and outer conductors, and a jacket that covers the outer conductor. Coaxial cable connectors may be applied to terminate coaxial cables, for example, in communications systems requiring a high level of precision and reliability.

Coaxial connector interfaces provide a connect/disconnect functionality between (a) a cable terminated with a connector bearing the desired connector interface and (b) a corresponding connector with a mating connector interface mounted on an electronic apparatus or on another cable. Typically, one connector will include a structure such as a pin or post connected to an inner conductor of the coaxial cable and an outer conductor connector body connected to the outer conductor of the coaxial cable which are mated with a mating sleeve (for the pin or post of the inner conductor) and another outer conductor connector body of a second connector. Coaxial connector interfaces often utilize a threaded coupling nut or other retainer that draws the connector interface pair into secure electro-mechanical engagement when the coupling nut (which is captured by one of the connectors) is threaded onto the other connector.

Passive Intermodulation Distortion (PIM) is a form of electrical interference/signal transmission degradation that may occur with less than symmetrical interconnections and/or as electro-mechanical interconnections shift or degrade over time. Interconnections may shift due to mechanical stress, vibration, thermal cycling, and/or material degradation. PIM can be an important interconnection quality characteristic, as PIM generated by a single low-quality interconnection may degrade the electrical performance of an entire RF system. Thus, the reduction of PIM through connector design is typically desirable.

### SUMMARY

A first aspect of the present invention is directed to a coaxial cable-connector assembly. The coaxial cable-connector assembly includes a coaxial cable, a coaxial connector, and a polymeric sleeve. The coaxial cable includes an inner conductor, a dielectric layer circumferentially surrounding the inner conductor, a corrugated outer conductor circumferentially surrounding the dielectric layer, and a jacket circumferentially surrounding the outer conductor. The coaxial connector includes an inner contact electrically connected with the inner conductor of the cable, an outer connector body having a shoulder on an inner surface, the outer connector body being spaced apart from and circumferentially surrounding the inner contact, a spring basket electrically connected with the outer conductor of the cable and configured to mate to an inner surface of the outer conductor, and an insulator interposed between the inner contact and the outer connector body. The polymeric sleeve resides between the outer conductor of the cable and the outer connector body of the connector. The outer connector body is swaged or crimped onto the polymeric sleeve. An end of the corrugated outer conductor is flared radially outwardly to form a flared end that secures the polymeric sleeve onto the coaxial cable. The polymeric sleeve separates the corrugated outer conductor of the coaxial cable from the outer conductor body of the coaxial connector to prevent direct radial electrical connection therebetween, and the polymeric sleeve axially forces the flared end of the outer conductor of the coaxial cable against the shoulder of the outer connector body of the coaxial connector.

Another aspect of the present invention is directed to a coaxial cable-connector assembly. The coaxial cable-connector assembly includes a coaxial cable, a coaxial connector, and a polymeric sleeve. The coaxial cable includes an inner conductor, a dielectric layer circumferentially surrounding the inner conductor, a corrugated outer conductor circumferentially surrounding the dielectric layer, and a jacket circumferentially surrounding the outer conductor. The coaxial connector includes an inner contact electrically connected with the inner conductor of the cable and an outer connector body having a shoulder on an inner surface and a collet at a rearward end. The collet includes a plurality of collet fingers separated by axial slots with the ends of each collet finger being bent radially inward to form flanged edges with a tapered inner surface. The outer connector body is spaced apart from and circumferentially surrounding the inner contact. The coaxial connector further includes a spring basket electrically connected with the outer conductor of the cable, the spring basket is configured to mate to an inner surface of the outer conductor, and an insulator interposed between the inner contact and the outer connector body. The polymeric sleeve resides between the outer conductor of the cable and the outer connector body of the connector. The polymer sleeve includes an annular flange extending radially outward, the annular flange having a tapered surface corresponding to the tapered inner surface of the flanged edges of the collet fingers. An end of the corrugated outer conductor is flared radially outwardly to form a flared end that secures the polymeric sleeve onto the coaxial cable. The polymeric sleeve separates the corrugated outer conductor from the outer conductor body to prevent direct radial electrical connection therebetween. The outer connector body is swaged or crimped onto the polymeric sleeve such that the tapered inner surface of each collet finger engages the tapered surface of the annular flange of the polymeric sleeve to axially force the polymeric sleeve against the flared end of the outer conductor of the coaxial cable and into the shoulder of the outer connector body of the coaxial connector.

Another aspect of the present invention is directed to a coaxial cable-connector assembly. The coaxial cable-connector assembly includes a coaxial cable, a coaxial connector, and a polymeric sleeve. The coaxial cable includes an inner conductor, a dielectric layer circumferentially surrounding the inner conductor, a corrugated outer conductor circumferentially surrounding the dielectric layer, and a jacket circumferentially surrounding the outer conductor. The coaxial connector includes an inner contact electrically connected with the inner conductor of the cable and an outer connector body and having a shoulder on an inner surface of the outer connector body and a collet at a rearward end. The collet includes a plurality of collet fingers separated by axial slots with the ends of each collet finger being bent radially inward to form flanged edges with a tapered inner surface. The outer connector body being spaced apart from and circumferentially surrounding the inner contact. The coaxial connector further includes a spring basket electrically connected with the outer conductor of the cable and configured to mate to an inner surface of the outer conductor, and an insulator interposed between the inner contact and the outer connector body. The polymeric sleeve resides between the outer conductor of the cable and the outer connector body of the connector. The polymer sleeve includes a plurality of fingers extending forwardly from an annular flange, the end of each finger a protrusion extending radially outward therefrom, the annular flange extends radially outward from the sleeve and has a tapered surface. An end of the corrugated outer conductor is flared radially outwardly to form a flared end that secures the polymeric sleeve onto the coaxial cable. The polymeric sleeve separates the corrugated outer conductor from the outer conductor body to prevent direct radial electrical connection therebetween. The outer connector body is swaged or crimped onto the polymeric sleeve such that the tapered inner surface of each collet finger engages the tapered surface of the annular flange of the polymeric sleeve to axially force the protrusions of the polymeric sleeve against the flared end of the outer conductor of the coaxial cable and into the shoulder of the outer connector body of the coaxial connector.

Another aspect of the present invention is directed to a coaxial cable-connector assembly. The coaxial cable-connector assembly includes a coaxial cable, a coaxial connector, and a polymeric sleeve. The coaxial cable includes an inner conductor, a dielectric layer circumferentially surrounding the inner conductor, a corrugated outer conductor circumferentially surrounding the dielectric layer, and a jacket circumferentially surrounding the outer conductor. The coaxial connector includes an inner contact electrically connected with the inner conductor of the cable, an outer connector body having a shoulder on an inner surface, the outer connector body being spaced apart from and circumferentially surrounding the inner contact, a spring basket electrically connected with the outer conductor of the cable and configured to mate to an inner surface of the outer conductor, and an insulator interposed between the inner contact and the outer connector body. The polymeric sleeve resides between the outer conductor of the cable and the outer connector body of the connector. The polymer sleeve includes a plurality of fingers extending forwardly from an annular flange, the end of each finger having a protrusion extending radially outward therefrom, the annular flange extends radially outward from the sleeve and has a recess. An end of the corrugated outer conductor is flared radially outwardly to form a flared end that secures the polymeric sleeve onto the coaxial cable. The polymeric sleeve separates the corrugated outer conductor from the outer conductor body to prevent direct radial electrical connection therebetween. The outer connector body is swaged or crimped onto the polymeric sleeve such that a portion of the outer connector body is deformed into the recess of the polymeric sleeve to axially force the protrusions of the polymeric sleeve against the flared end of the outer conductor of the coaxial cable and into the shoulder of the outer connector body of the coaxial connector.

Another aspect of the present invention is directed to a coaxial cable-connector assembly. The coaxial cable-connector assembly includes a coaxial cable, a coaxial connector, and a polymeric sleeve. The coaxial cable includes an inner conductor, a dielectric layer circumferentially surrounding the inner conductor, a corrugated outer conductor circumferentially surrounding the dielectric layer, and a jacket circumferentially surrounding the outer conductor. The coaxial connector includes an inner contact electrically connected with the inner conductor of the cable, an outer connector body having a shoulder on an inner surface, the outer connector body being spaced apart from and circumferentially surrounding the inner contact, a spring basket electrically connected with the outer conductor of the cable and configured to mate to an inner surface of the outer conductor, and an insulator interposed between the inner contact and the outer connector body. The polymeric sleeve resides between the outer conductor of the cable and the outer connector body of the connector. The polymeric sleeve includes a recess and the outer connector body is swaged or crimped onto the polymeric sleeve such that a portion of the outer connector body is deformed into the recess. An end of the corrugated outer conductor is flared radially outwardly to form a flared end that secures the polymeric sleeve onto the coaxial cable. The polymeric sleeve separates the corrugated outer conductor from the outer conductor body to prevent direct radial electrical connection therebetween, and the polymeric sleeve axially forces the flared end of the outer conductor of the coaxial cable against the shoulder of the outer connector body of the coaxial connector.

Another aspect of the present invention is directed to a method of assembling a coaxial cable-connector assembly. The method includes: (a) providing a coaxial cable having an inner conductor, a dielectric layer circumferentially surrounding the inner conductor, an outer conductor circumferentially surrounding the dielectric layer, and a jacket circumferentially surrounding the outer conductor; (b) providing a coaxial connector having an inner contact, an outer connector body spaced apart from and circumferentially surrounding the inner contact, a spring basket configured to mate to an inner surface of the outer conductor, and an insulator interposed between the inner contact and the outer connector body; (c) stripping the jacket of the cable to expose a portion of the outer conductor; (d) stripping the outer conductor and dielectric layer to expose the end of the inner conductor; (e) sliding a strain relief sleeve over the end of the cable and onto an unstripped portion of the cable jacket; (f) securing a gasket around the outer conductor; (g) securing a polymeric sleeve around the outer conductor; (h) flaring the end of the outer conductor radially outward; (i) sliding the connector onto the cable until a shoulder on an inner surface of the outer connector body contacts the flared end of the outer conductor such that the outer connector body makes electrical contact with the outer conductor of the cable, and the spring basket makes electrical contact with outer conductor of the cable such that the inner contact make electrical contact with inner conductor of the cable; (j) crimping or swaging the outer connector body of the connector onto the sleeve such that the sleeve axially forces the flared end of the outer conductor against the shoulder of the outer connector body; and (k) sliding the strain relief sleeve back toward the end of the cable to engage the connector.

Another aspect of the present invention is directed to a method of assembling a coaxial cable-connector assembly. The method includes: (a) providing a coaxial cable having an inner conductor, a dielectric layer circumferentially surrounding the inner conductor, an outer conductor circumferentially surrounding the dielectric layer, and a jacket circumferentially surrounding the outer conductor; (b) providing a coaxial connector having an inner contact, an outer connector body spaced apart from and circumferentially surrounding the inner contact, a spring basket configured to mate to an inner surface of the outer conductor, and an insulator interposed between the inner contact and the outer connector body, the outer connector body having a collet at a rearward end, the collet including a plurality of collet fingers separated by axial slots, the ends of each collet finger being bent radially inward to form flanged edges with a tapered inner surface; (c) stripping the jacket of the cable to expose a portion of the outer conductor; (d) stripping the outer conductor and dielectric layer to expose the end of the inner conductor; (e) sliding a strain relief sleeve over the end of the cable and onto an unstripped portion of the cable jacket; (f) securing a gasket around the outer conductor; (g) securing a polymeric sleeve around the outer conductor, the polymer sleeve comprising an annular flange extending radially outward, the annular flange having a tapered surface corresponding to the tapered inner surface of the flanged edges of the collet fingers; (h) flaring the end of the outer conductor radially outward; (i) sliding the connector onto the cable until a shoulder on an inner surface of the outer connector body contacts the flared end of the outer conductor such that the outer connector body makes electrical contact with the outer conductor of the cable, and the spring basket makes electrical contact with outer conductor of the cable such that the inner contact make electrical contact with inner conductor of the cable; (j) crimping or swaging the outer connector body of the connector onto the sleeve such that the tapered inner surface of each collet finger engages the tapered surface of the annular flange of the polymeric sleeve to axially force the polymeric sleeve against the flared end of the outer conductor of the coaxial cable and in contact with the shoulder of the outer connector body of the coaxial connector; and (k) sliding the strain relief sleeve back toward the end of the cable to engage the connector.

Another aspect of the present invention is directed to a method of assembling a coaxial cable-connector assembly. The method includes: (a) providing a coaxial cable having an inner conductor, a dielectric layer circumferentially surrounding the inner conductor, an outer conductor circumferentially surrounding the dielectric layer, and a jacket circumferentially surrounding the outer conductor; (b) providing a coaxial connector having an inner contact, an outer connector body spaced apart from and circumferentially surrounding the inner contact, a spring basket configured to mate to an inner surface of the outer conductor, and an insulator interposed between the inner contact and the outer connector body, the outer connector body having a collet at a rearward end, the collet including a plurality of collet fingers separated by axial slots, the ends of each collet finger being bent radially inward to form flanged edges with a tapered inner surface; (c) stripping the jacket of the cable to expose a portion of the outer conductor; (d) stripping the outer conductor and dielectric layer to expose the end of the inner conductor; (e) sliding a strain relief sleeve over the end of the cable and onto an unstripped portion of the cable jacket; (f) securing a gasket around the outer conductor; (g) securing a polymeric sleeve around the outer conductor, the polymer sleeve including a plurality of fingers extending forwardly from an annular flange, the end of each finger having a protrusion extending radially outward therefrom, the annular flange extends radially outward from the sleeve and has a tapered surface; (h) flaring the end of the outer conductor radially outward; (i) sliding the connector onto the cable until a shoulder on an inner surface of the outer connector body contacts the flared end of the outer conductor such that the outer connector body makes electrical contact with the outer conductor of the cable, and the spring basket makes electrical contact with outer conductor of the cable such that the inner contact make electrical contact with inner conductor of the cable; (j) crimping or swaging the outer connector body of the connector onto the sleeve such that the tapered inner surface of each collet finger engages the tapered surface of the annular flange of the polymeric sleeve to axially force the protrusions of the polymeric sleeve against the flared end of the outer conductor of the coaxial cable and in contact with the shoulder of the outer connector body of the coaxial connector; and (k) sliding the strain relief sleeve back toward the end of the cable to engage the connector.

Another aspect of the present invention is directed to a method of assembling a coaxial cable-connector assembly. The method includes: (a) providing a coaxial cable having an inner conductor, a dielectric layer circumferentially surrounding the inner conductor, an outer conductor circumferentially surrounding the dielectric layer, and a jacket circumferentially surrounding the outer conductor; (b) providing a coaxial connector having an inner contact, an outer connector body spaced apart from and circumferentially surrounding the inner contact, a spring basket configured to mate to an inner surface of the outer conductor, and an insulator interposed between the inner contact and the outer connector body; (c) stripping the jacket of the cable to expose a portion of the outer conductor; (d) stripping the outer conductor and dielectric layer to expose the end of the inner conductor; (e) sliding a strain relief sleeve over the end of the cable and onto an unstripped portion of the cable jacket; (f) securing a gasket around the outer conductor; (g) securing a polymeric sleeve around the outer conductor, the polymer sleeve including a plurality of fingers extending forwardly from an annular flange, the end of each finger having a protrusion extending radially outward therefrom, the annular flange extends radially outward from the sleeve and comprises a recess; (h) flaring the end of the outer conductor radially outward; (i) sliding the connector onto the cable until a shoulder on an inner surface of the outer connector body contacts the flared end of the outer conductor such that the outer connector body makes electrical contact with the outer conductor of the cable, and the spring basket makes electrical contact with outer conductor of the cable such that the inner contact make electrical contact with inner conductor of the cable; (j) crimping or swaging the outer connector body of the connector onto the sleeve such a portion of the outer connector body is deformed into the recess of the polymeric sleeve to axially force the protrusions of the polymeric sleeve against the flared end of the outer conductor of the coaxial cable and in contact with the shoulder of the outer connector body of the coaxial connector; and (k) sliding the strain relief sleeve back toward the end of the cable to engage the connector.

Another aspect of the present invention is directed to s coaxial cable-connector assembly. The assembly includes a coaxial cable, a coaxial connector, and a polymeric sleeve. The coaxial cable includes an inner conductor, a dielectric layer circumferentially surrounding the inner conductor, a corrugated outer conductor circumferentially surrounding the dielectric layer, and a jacket circumferentially surrounding the outer conductor. The coaxial connector includes an inner contact electrically connected with the inner conductor of the cable, an outer connector body being spaced apart from and circumferentially surrounding the inner contact, a spring basket electrically connected with the outer conductor of the cable configured to mate to an inner surface of the outer conductor; and an insulator interposed between the inner contact and the outer connector body. The polymeric sleeve resides between the outer conductor of the cable and the outer connector body of the connector to prevent direct radial electrical connection therebetween, and the outer connector body is swaged or crimped onto the polymeric sleeve which axially forces the outer conductor of the coaxial cable into contact with the outer connector body of the coaxial connector.

Another aspect of the present invention is directed to a coaxial cable-connector assembly. The assembly includes a coaxial cable and a coaxial connector. The coaxial cable includes an inner conductor, a dielectric layer circumferentially surrounding the inner conductor, a corrugated outer conductor circumferentially surrounding the dielectric layer, and a jacket circumferentially surrounding the outer conductor. The coaxial connector includes an inner contact electrically connected with the inner conductor of the cable, an outer connector body having a shoulder on an inner surface, the outer connector body being spaced apart from and circumferentially surrounding the inner contact, and an insulator interposed between the inner contact and the outer connector body. The assembly further includes a polymeric sleeve residing between the outer conductor of the cable and the outer connector body of the connector, and a backing ring circumferentially surrounding a segment of the dielectric layer on the coaxial cable and residing between the insulator of the coaxial connector and the sleeve, the backing ring making radial contact with the outer connector body. An end of the corrugated outer conductor is flared radially outwardly to form a flared end that secures the polymeric sleeve onto the coaxial cable, the polymeric sleeve separates the corrugated outer conductor of the coaxial cable from the outer conductor body of the coaxial connector to prevent direct radial electrical connection therebetween, and the polymeric sleeve axially forces with a press-fit the flared end of the outer conductor of the coaxial cable into contact with the backing ring.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a side view of a coaxial cable-connector assembly for a helical cable according to embodiments of the present invention.

FIG. 1B is a cross-sectional side view of the assembly of FIG. 1A.

FIG. 2A is a side view of the coaxial cable of the assembly of FIG. 1A, prior to the end of the cable being prepared (i.e., flared), according to embodiments of the present invention.

FIG. 2B is a cross-sectional side view of the cable of FIG. 2A.

FIG. 3A is a cross-sectional side view of a prepared cable of the assembly of FIG. 1A according to embodiments of the present invention.

FIG. 313 is a perspective view of the prepared cable of FIG. 3A.

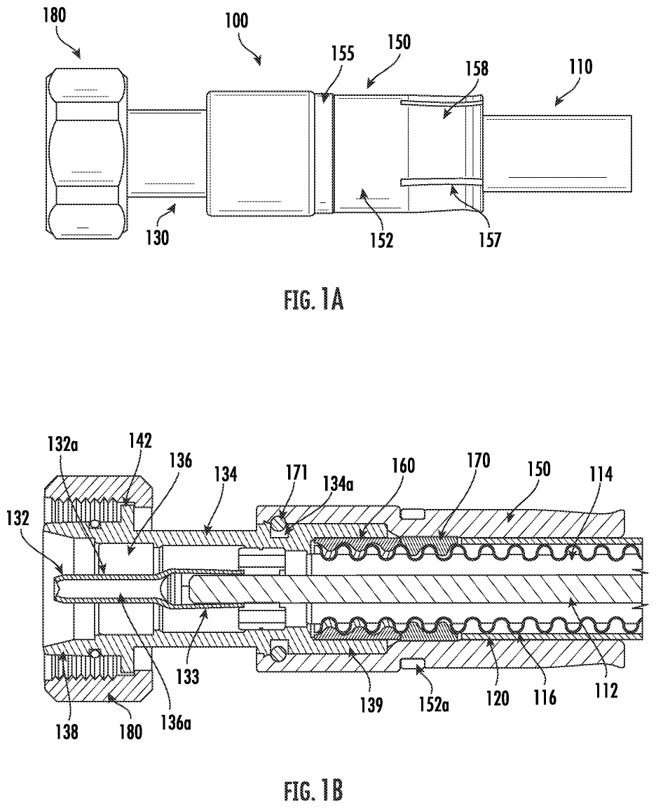

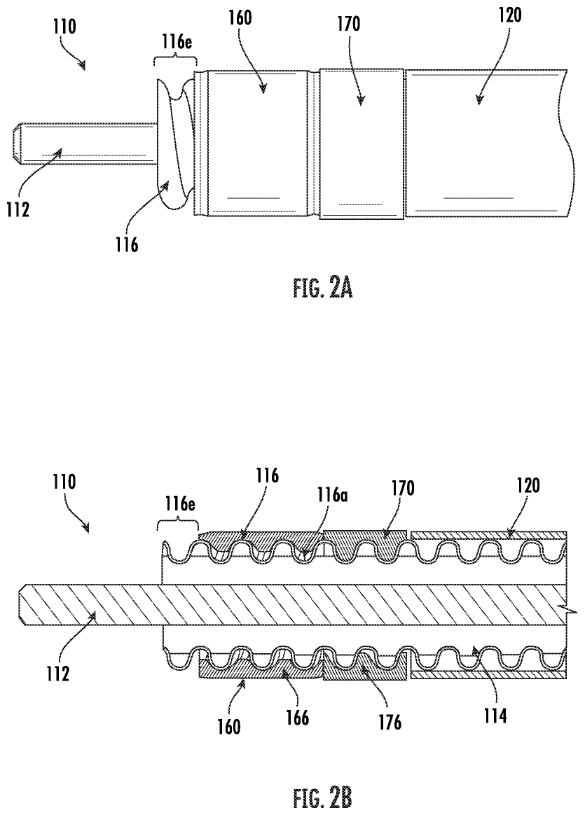

FIG. 4 is a perspective view of a coaxial connector of the assembly of FIG. 1A according to embodiments of the present invention.

FIG. 5 is a cross-sectional side view of the assembly prior to the connector being pushed onto the prepared cable.

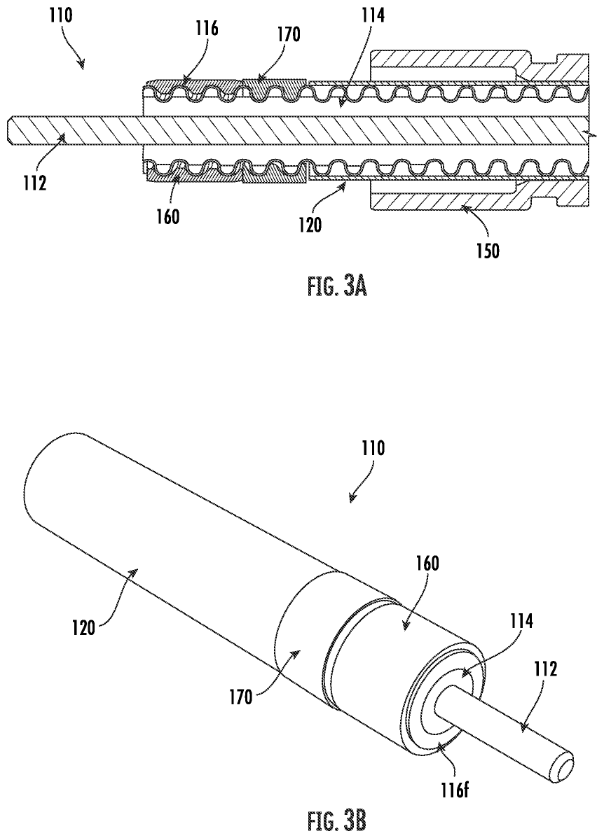

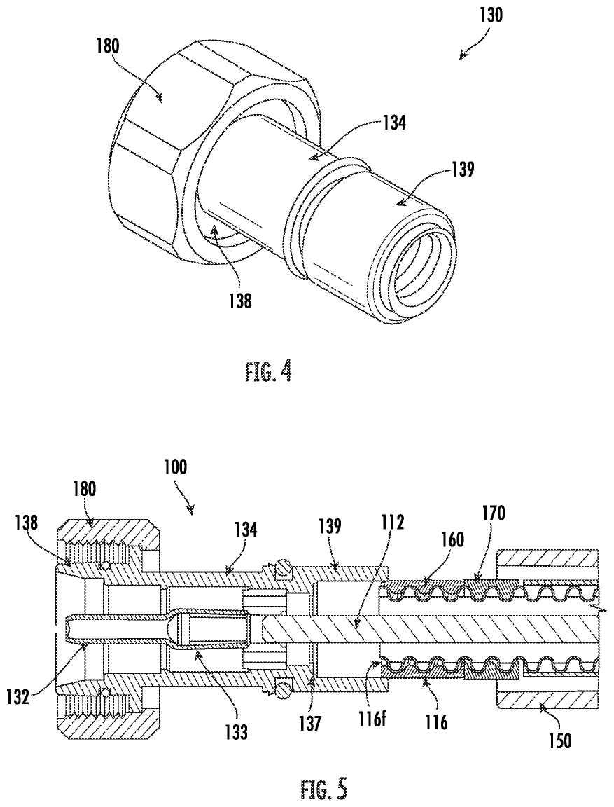

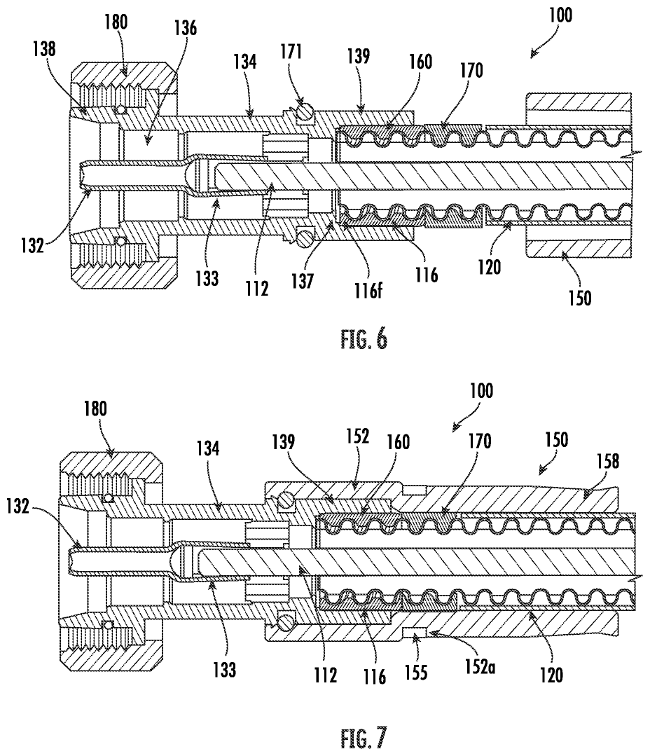

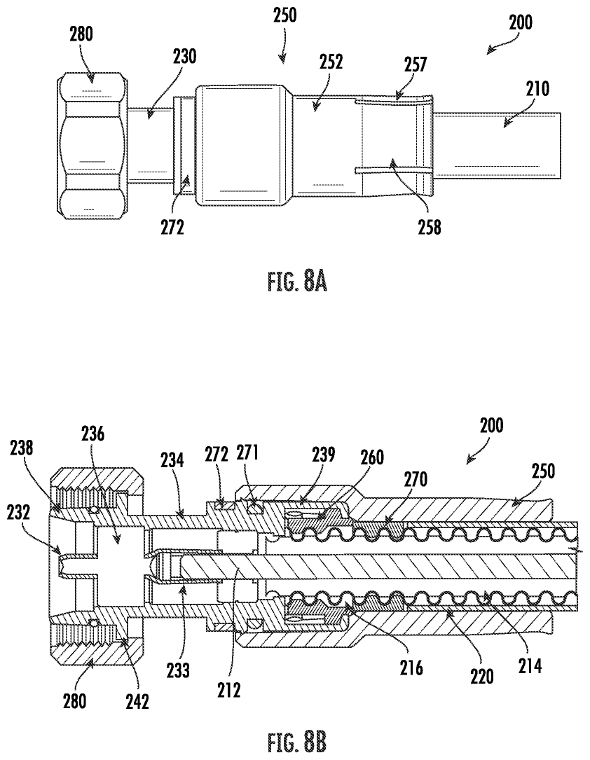

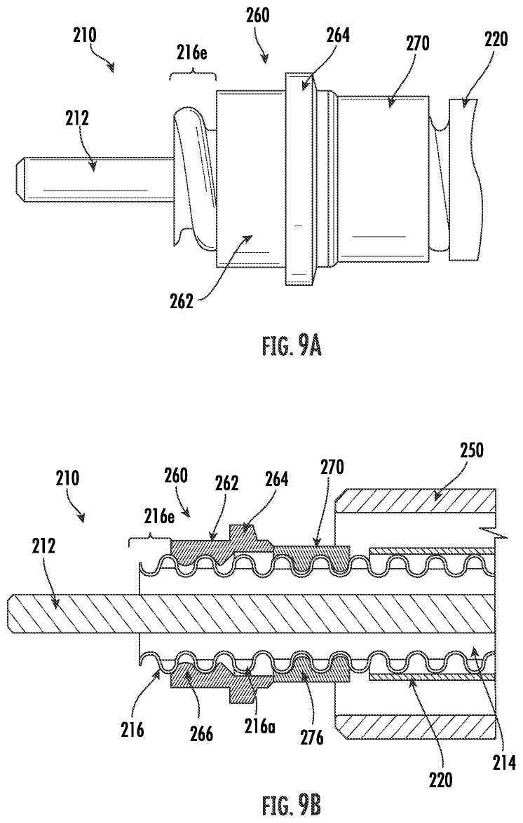

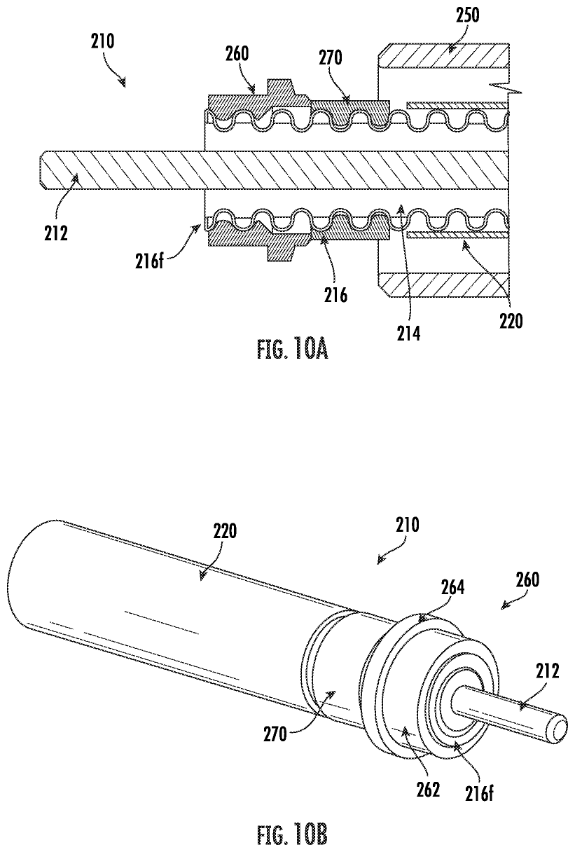

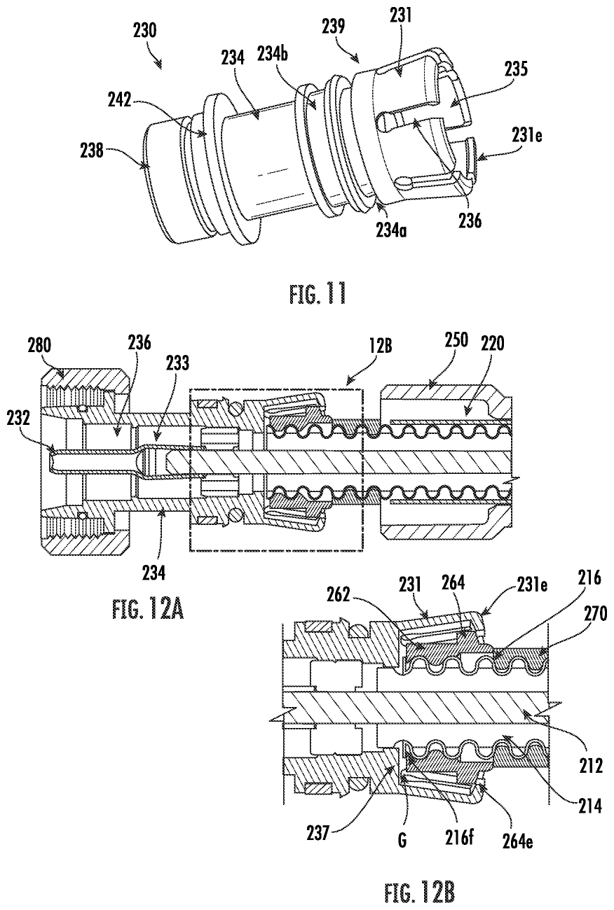

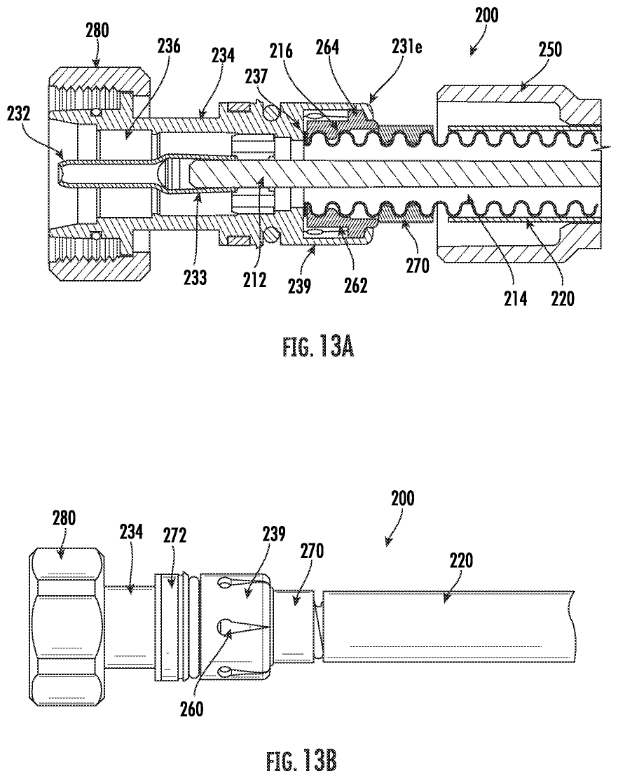

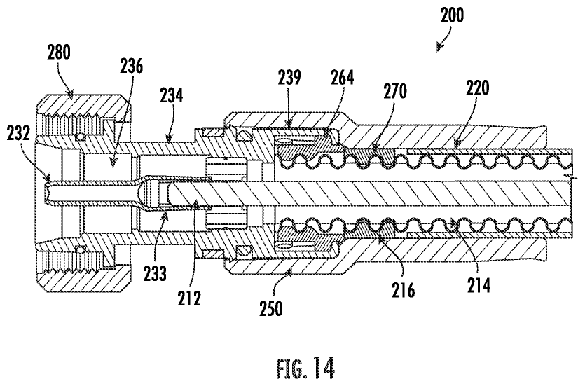

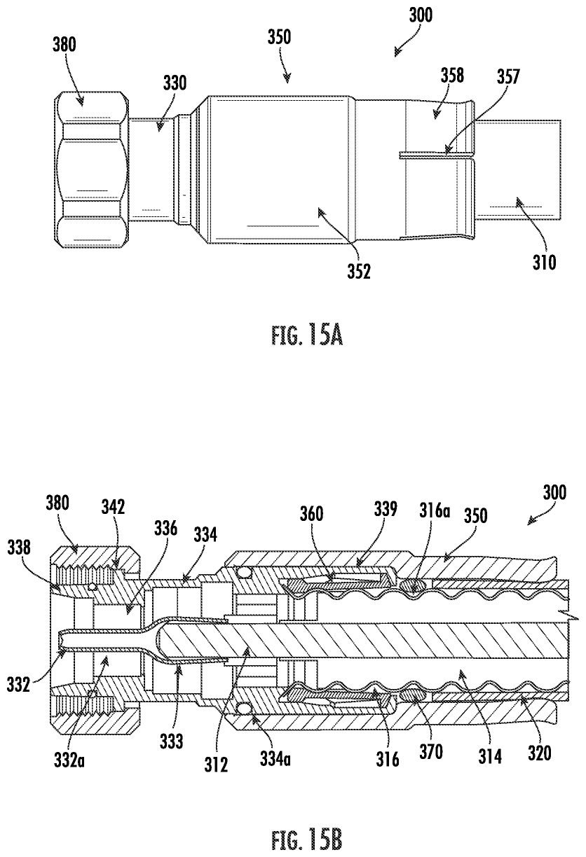

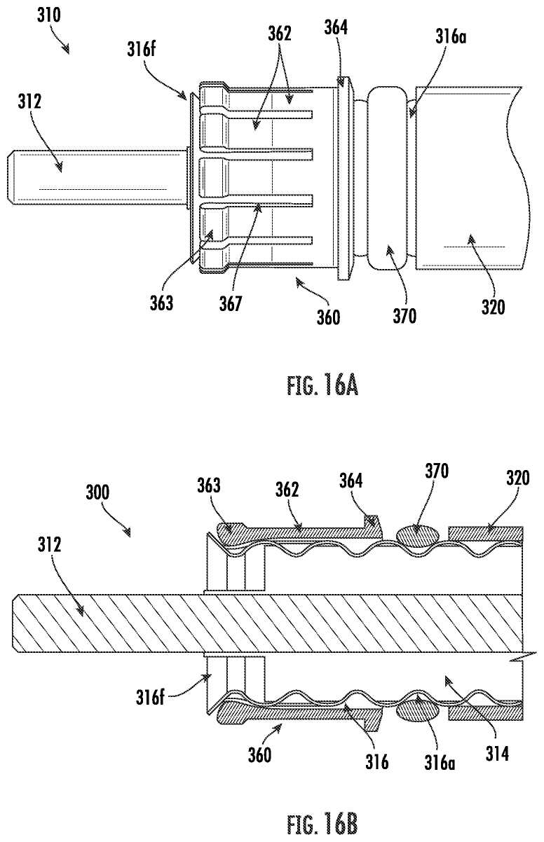

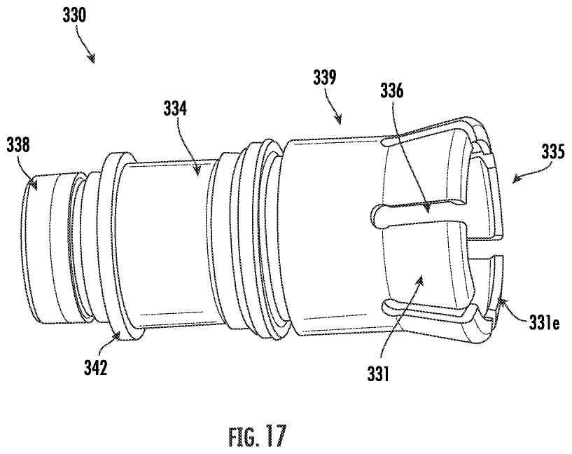

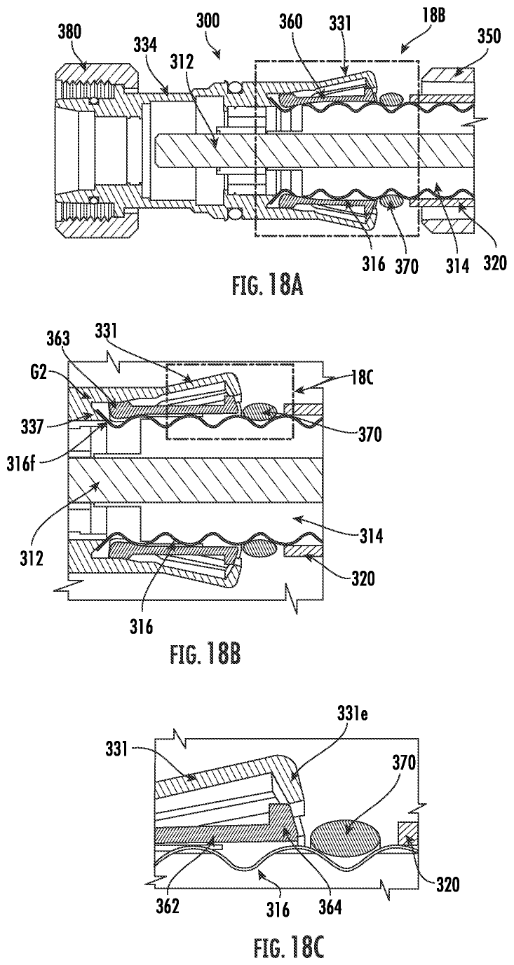

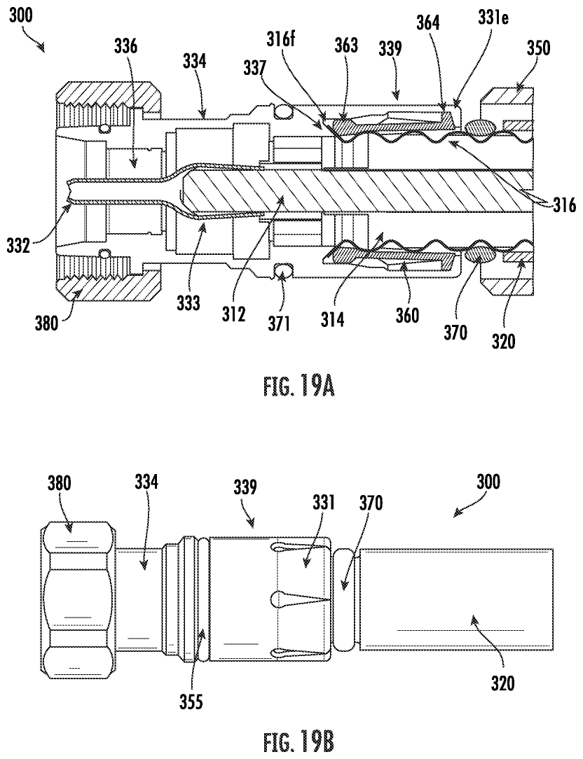

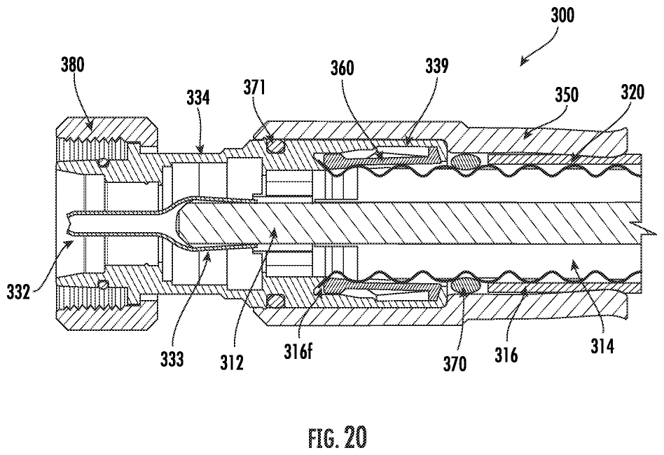

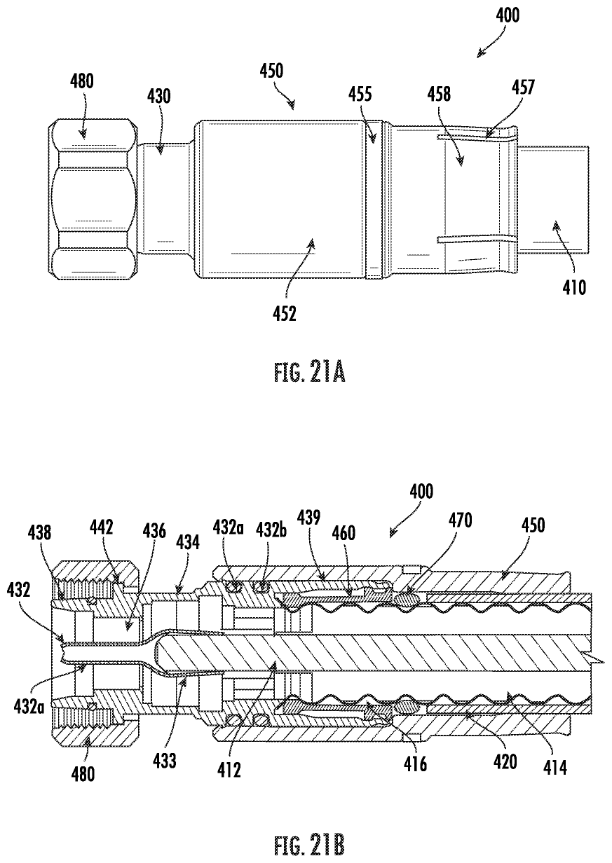

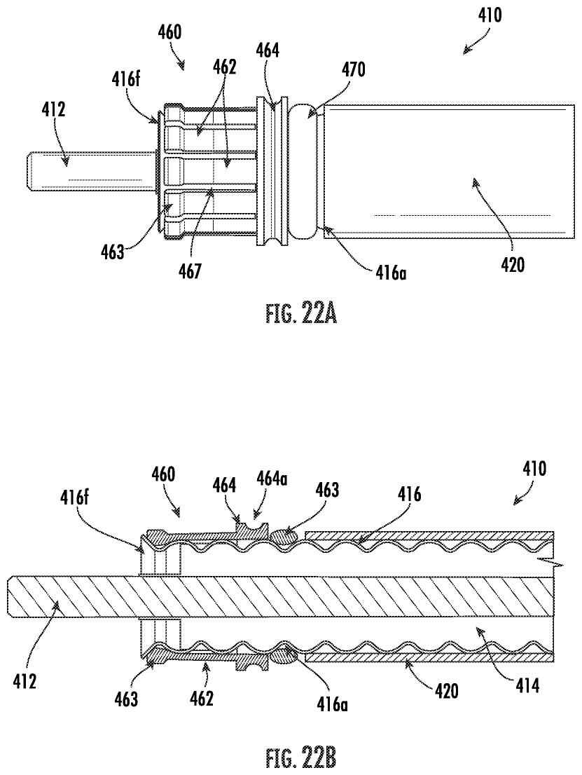

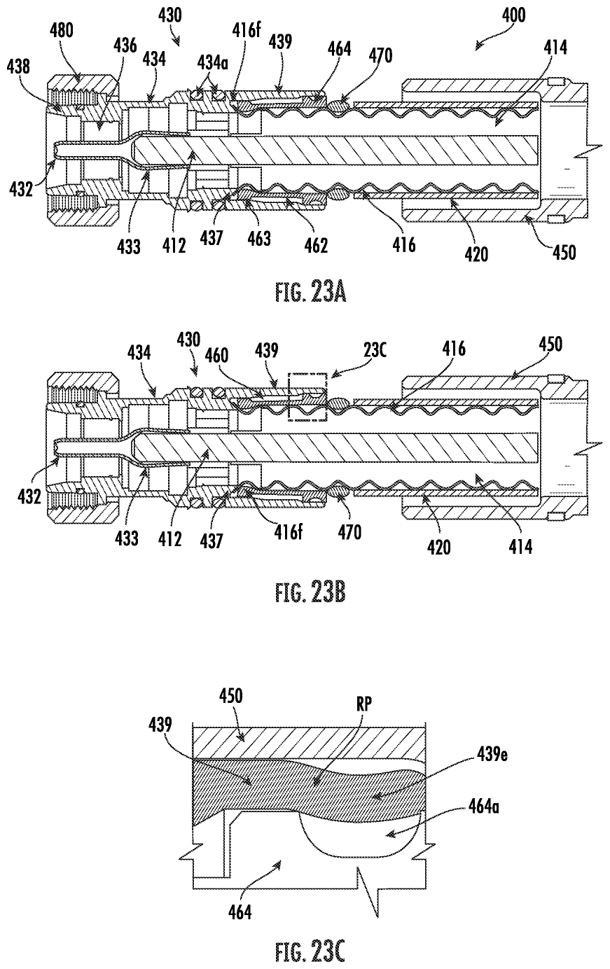

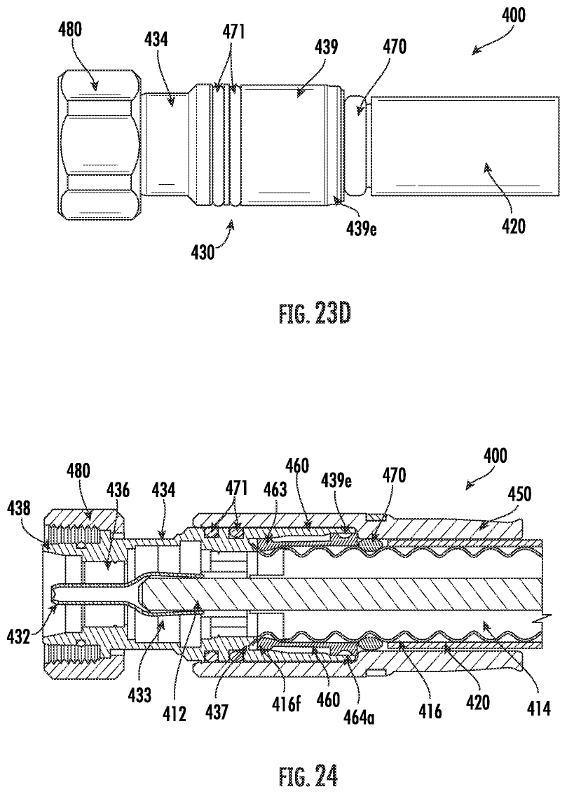

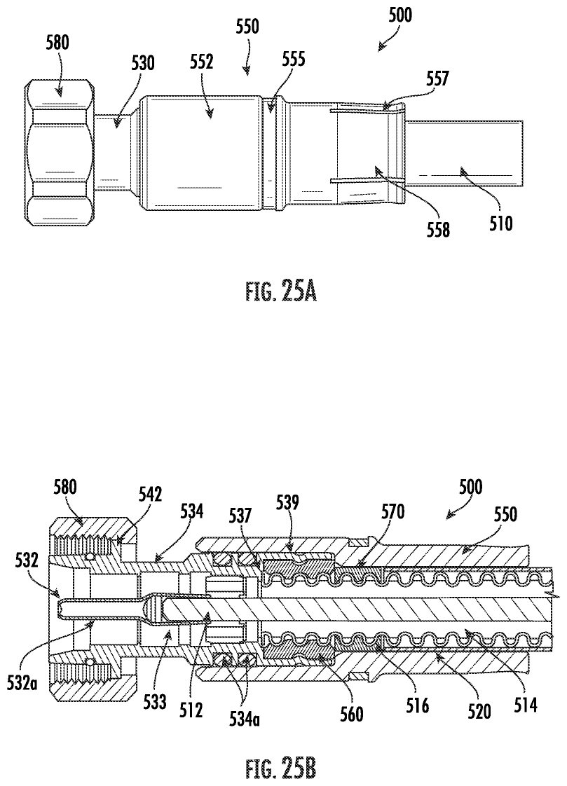

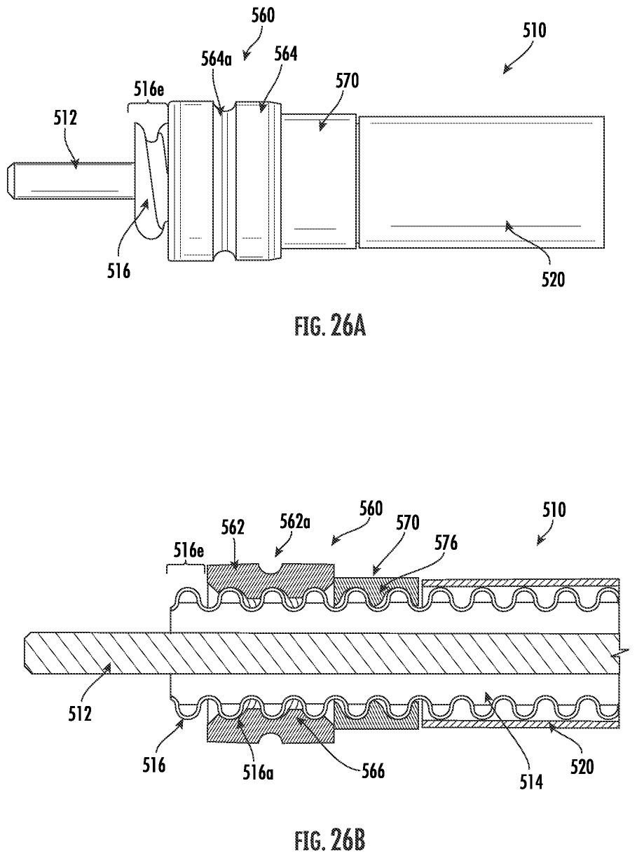

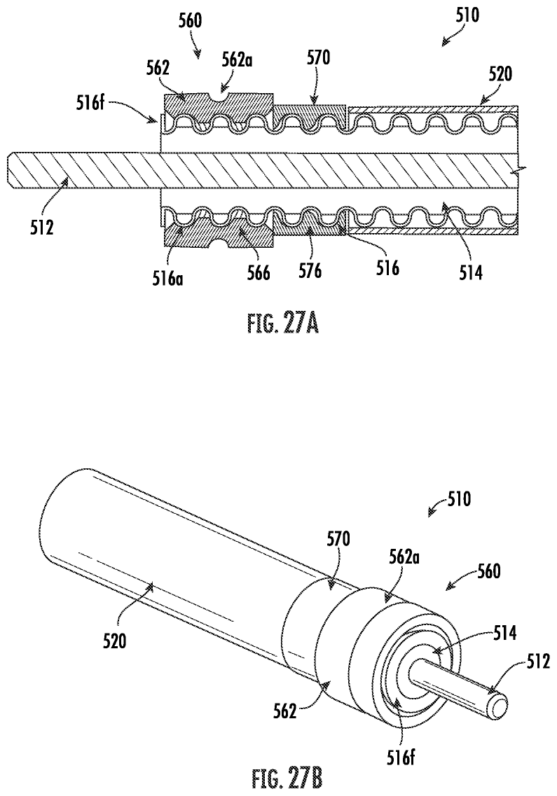

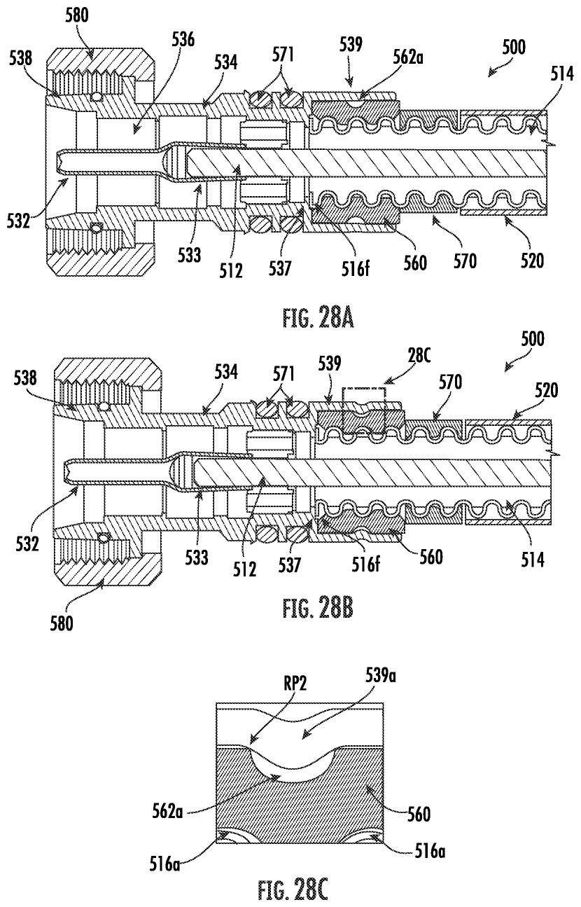

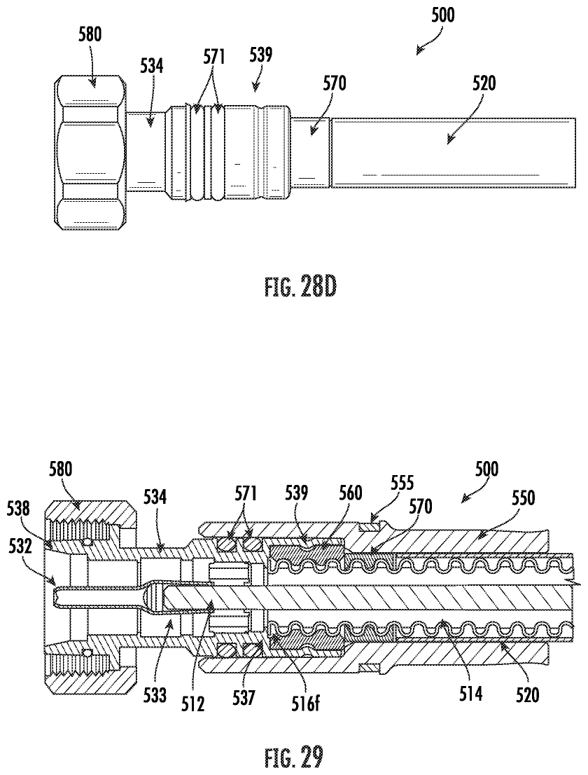

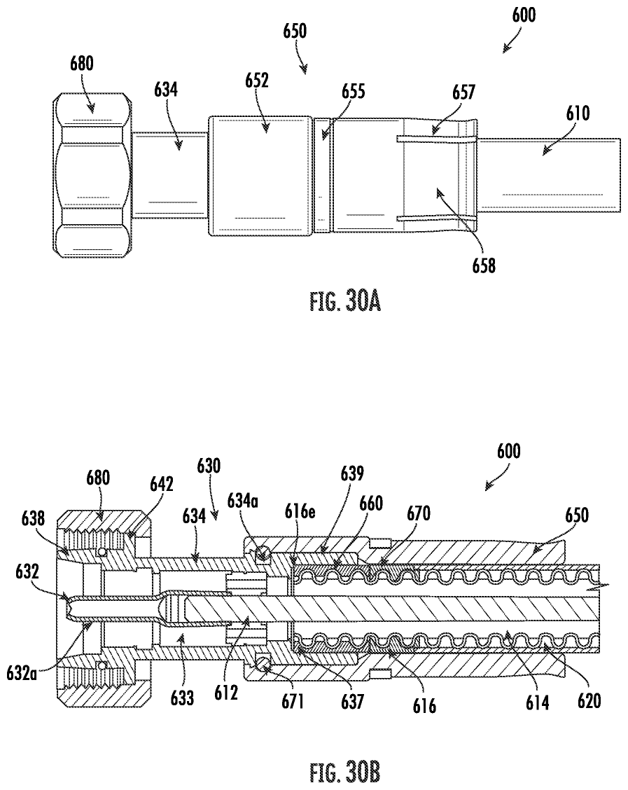

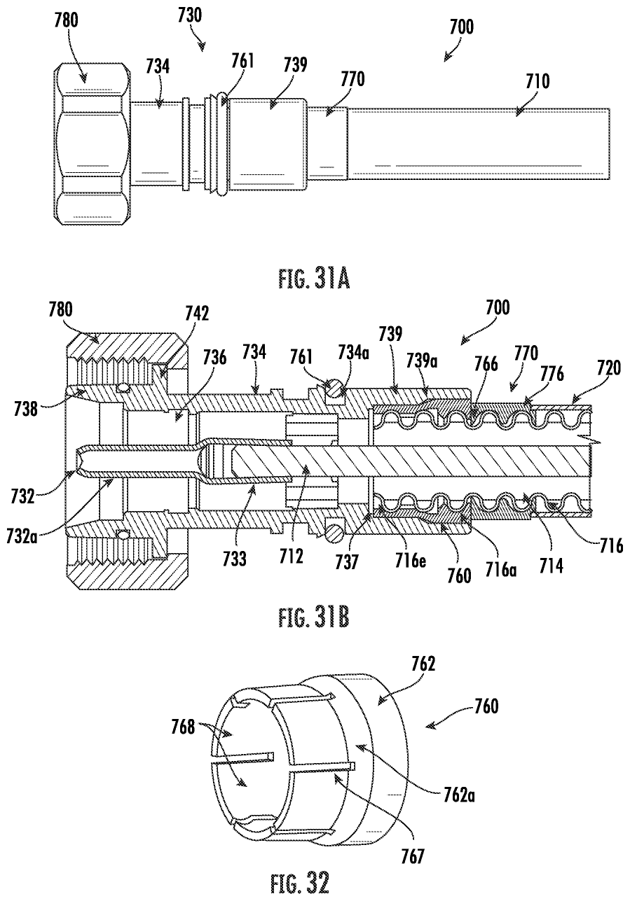

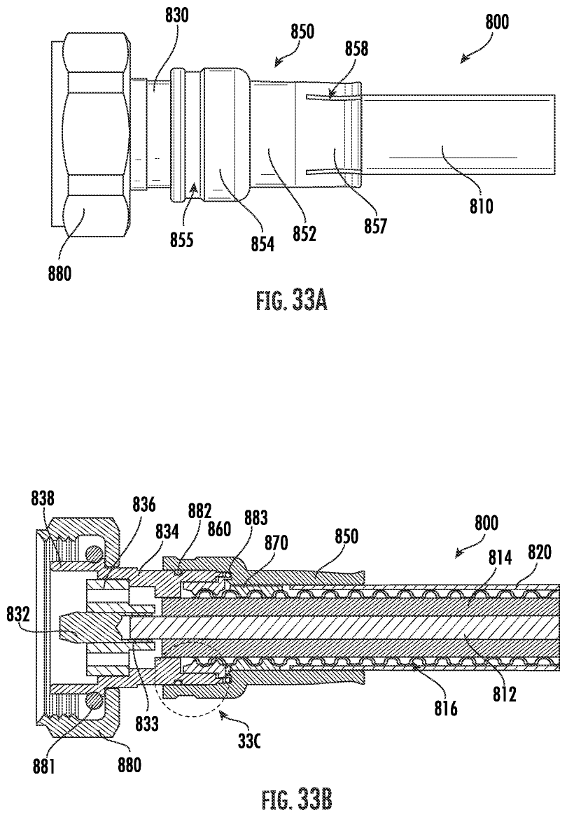

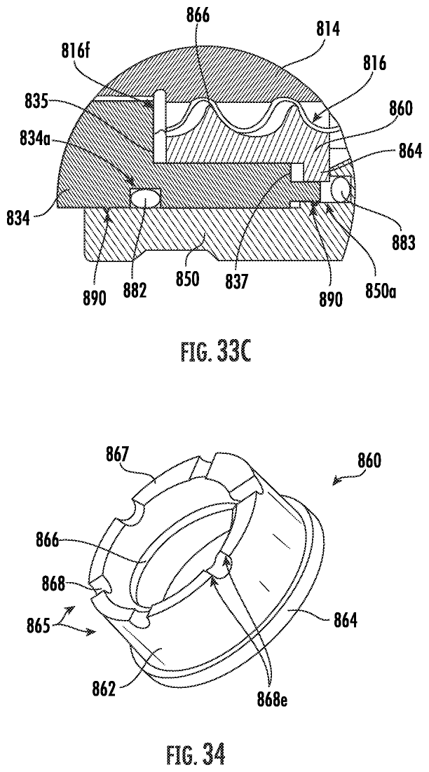

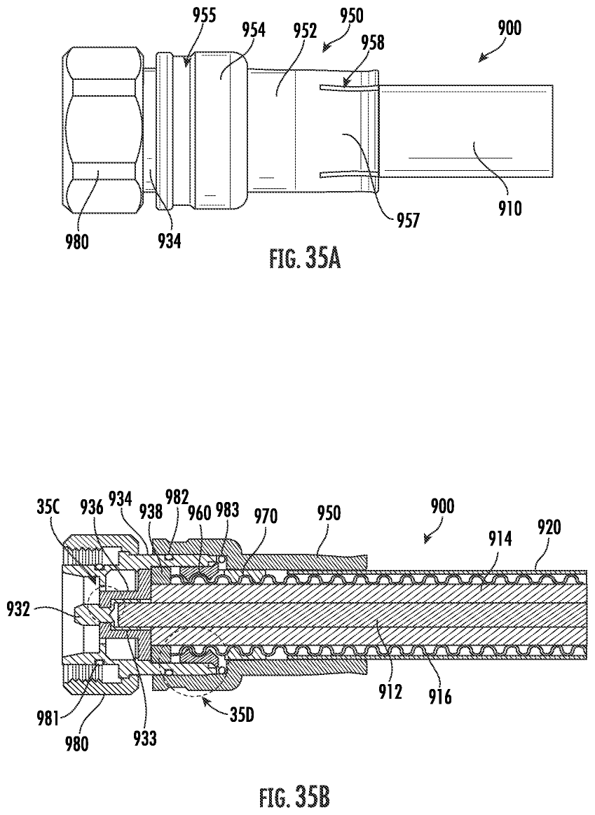

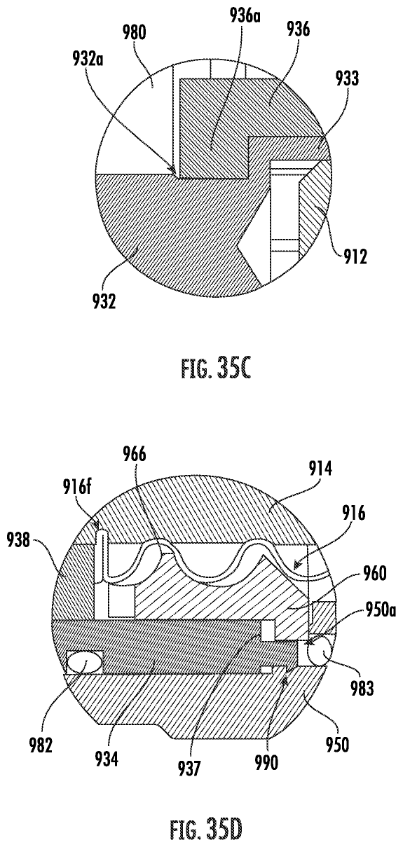

FIG. 6 is a cross-sectional side view of the assembly with the connector of FIG. 4 pushed onto the prepared cable of FIG. 3A according to embodiments of the present invention.

FIG. 7 is a cross-sectional side view of the assembly with a strain relief sleeve pushed over the cable-connector interface according to embodiments of the present invention.

FIG. 8A is a side view of a coaxial cable-connector assembly for an annular cable according to embodiments of the present invention.

FIG. 8B is a cross-sectional side view of the assembly of FIG. 8A.

FIG. 9A is a side view of the coaxial cable of the assembly of FIG. 8A, prior to the end of the cable being prepared (i.e., flared), according to embodiment of the present invention.

FIG. 913 is a cross-sectional side view of the cable of FIG. 9A.

FIG. 10A is a cross-sectional side view of a prepared cable of the assembly of FIG. 8A according to embodiments of the present invention.

FIG. 10B is a perspective view of the prepared cable of FIG. 10A.

FIG. 11 is a perspective view of a coaxial connector of the assembly of FIG. 8A according to embodiments of the present invention.

FIG. 12A is a cross-sectional side view of the assembly with the connector of FIG. 11 pushed onto the prepared cable, but prior to the connector being secured to the cable, according to embodiments of the present invention.

FIG. 12B is an enlarged cross-sectional side view of the inset section labeled “12B” in FIG. 12A.

FIG. 13A is a cross-sectional side view of the assembly with the connector secured to the prepared cable according to embodiments of the present invention.

FIG. 13B is a perspective view of the assembly of FIG. 13A.

FIG. 14 is a cross-sectional side view of the assembly of FIG. 13A with a strain relief sleeve pushed over the cable-connector interface according to embodiments of the present invention.

FIG. 15A is a side view of an alternative coaxial cable-connector assembly for an annular cable according to embodiments of the present invention.

FIG. 15B is a cross-sectional side view of the assembly of FIG. 15A.

FIG. 16A is a side view of a prepared cable of the assembly of FIG. 15A according to embodiments of the present invention.

FIG. 16B is a cross-sectional side view of the prepared cable of FIG. 16A.

FIG. 17 is a perspective view of a coaxial connector of the assembly of FIG. 15A according to embodiments of the present invention.

FIG. 18A is a cross-sectional side view of the assembly with the connector of FIG. 17 pushed onto the prepared cable, but prior to the connector being secured to the cable, according to embodiments of the present invention.

FIG. 18B is an enlarged cross-sectional side view of the inset section labeled “18B” in FIG. 18A.

FIG. 18C is an enlarged cross-sectional side view of the inset section labeled “18C” in FIG. 18B.

FIG. 19A is a cross-sectional side view of the assembly with the connector pushed onto, and secured to, the prepared cable, according to embodiments of the present invention.

FIG. 19B is a side view of the assembly of FIG. 19A.

FIG. 20 is a cross-sectional side view of the assembly of FIG. 19A with a strain relief sleeve pushed over the cable-connector interface according to embodiments of the present invention.

FIG. 21A is a side view of an alternative coaxial cable-connector assembly for an annular cable according to embodiments of the present invention.

FIG. 21B is a cross-sectional side view of the assembly of FIG. 21A.

FIG. 22A is a side view of a prepared cable of the assembly of FIG. 21A according to embodiments of the present invention.

FIG. 22B is a cross-sectional side view of the prepared cable of FIG. 21A.

FIG. 23A is a cross-sectional side view of the assembly with the connector pushed onto the prepared cable, but prior to being secured to the cable, according to embodiments of the present invention.

FIG. 23B is a cross-sectional side view of the assembly with the connector secured to the prepared cable according to embodiments of the present invention.

FIG. 23C is an enlarged cross-sectional view of the inset section labeled “23C” in FIG. 23B.

FIG. 23D is a side view of the assembly of FIG. 23B.

FIG. 24 is a cross-sectional side view of the assembly of FIG. 23D with a strain relief sleeve pushed over the cable-connector interface according to embodiments of the present invention.

FIG. 25A is a side view of an alternative coaxial cable-connector assembly for a helical cable according to embodiments of the present invention.

FIG. 25B is a cross-sectional side view of the assembly of FIG. 25A.

FIG. 26A is a side view of the coaxial cable of the assembly of FIG. 25A, prior to the end of the cable being prepared (i.e., flared), according to embodiments of the present invention.

FIG. 26B is a cross-sectional side view of the cable of FIG. 26A.

FIG. 27A is a cross-sectional side view of a prepared cable of the assembly of FIG. 25A according to embodiments of the present invention.

FIG. 2713 is a perspective view of the prepared cable of FIG. 27A.

FIG. 28A is a cross-sectional side view of the assembly with the connector pushed onto the prepared cable, but prior to being secured to the cable, according to embodiments of the present invention.

FIG. 28B is a cross-sectional side view of the assembly with the connector secured to the prepared cable according to embodiments of the present invention.

FIG. 28C is an enlarged cross-sectional view of the squared-section labeled “28C” in FIG. 28B.

FIG. 28D is a side view of the assembly of FIG. 28B.

FIG. 29 is a cross-sectional side view of the assembly of FIG. 28D with a strain relief sleeve pushed over the cable-connector interface according to embodiments of the present invention.

FIG. 30A is a side view of an alternative coaxial cable-connector assembly for a helical cable according to embodiments of the present invention.

FIG. 30B is a cross-sectional side view of the assembly of FIG. 30A.

FIG. 31A is a side view of an alternative coaxial cable-connector assembly for a helical cable according to embodiments of the present invention.

FIG. 31B is a cross-sectional side view of the assembly of FIG. 31A.

FIG. 32 is a perspective view of a sleeve of the assembly of FIG. 31A according to embodiments of the present invention.

FIG. 33A is a side view of an alternative coaxial cable-connector assembly for a helical cable according to embodiments of the present invention.

FIG. 33B is a cross-sectional side view of the assembly of FIG. 33A.

FIG. 33C is an enlarged cross-sectional side view of the inset section labeled “33C” in FIG. 33B.

FIG. 34 is a perspective view of a sleeve of the assembly of FIG. 33A according to embodiments of the present invention.

FIG. 35A is a side view of an alternative coaxial cable-connector assembly for a helical cable according to embodiments of the present invention.

FIG. 35B is a cross-sectional side view of the assembly of FIG. 35A.

FIG. 35C is an enlarged cross-sectional side view of the inset section labeled “35C” in FIG. 35B.

FIG. 35D is an enlarged cross-sectional side view of the inset section labeled “35D” in FIG. 35B.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

Current coaxial cable-connector assemblies are factory-made using solder processes for attachment and ingress protection. It may be desirable to move the manufacture of these assemblies to a store-front type low overhead facility which precludes solder due to expensive equipment costs. Embodiments of the present invention may help to achieve high performance coaxial cable-connector assemblies which take advantage of a store-front type low overhead facility to reduce connector cost and attachment costs.

Referring now to the figures, a coaxial cable-connector assembly according to embodiments of the present invention, designated broadly at 100, is illustrated in FIGS. 1A-7. As shown in FIG. 1A, the assembly 100 includes a coaxial cable 110 and a connector 130 attached to one end thereof. The connection interface between the connector 130 and the coaxial cable 110 is protected by a strain relief sleeve 150. The coaxial cable-connector assembly 100 illustrated in FIGS. 1A-7 provides a push and press-fit design which helps to reduce attachment costs and allows the assembly 100 to be manufactured in a store-front setting.

As shown in FIG. 113 (see also, e.g., FIGS. 2A-3B and FIGS. 5-7), the coaxial cable 110 includes an inner conductor 112, a dielectric layer 114 that circumferentially overlies the inner conductor 112, a corrugated outer conductor 116 that circumferentially overlies the dielectric layer 114, and a polymeric cable jacket 120 that circumferentially overlies the outer conductor 116. These components will be well-known to those of ordinary skill in the art and need not be described in detail herein. It is noted that the cable 110 for the coaxial cable-connector assembly 100 has a helical corrugated outer conductor 116 (see, e.g., FIG. 2A). In other embodiments of the present invention, the coaxial cable 110 may have an annular corrugated outer conductor 116, for example, as discussed in further detail below with respect to FIGS. 15A-20 and FIGS. 21A-24.

Still referring to FIG. 1B, the connector 130 includes an inner contact 132, an outer connector body 134, and an insulator 136. The inner contact 132 has a generally cylindrical post 132a and is mounted on, and is in electrical contact with, the inner conductor 112 of the cable 110. In some embodiments, the inner contact 132 is in electrical contact with the inner conductor 112 via a spring basket 133 (see also, e.g., FIGS. 6-7).

The outer connector body 134 includes a mating end 138 that is configured to mate with the outer conductor body of a mating jack (see also, e.g., FIG. 4). The mating end 138 extends forwardly from one end of the outer connector body 134. In some embodiments, the mating end 138 may be tapered. A flange 142 extends radially outwardly from the outer conductor body 134 and provides a bearing surface for a coupling nut 180. At its rearward end, as shown in FIG. 4, the outer connector body 134 has a tail section 139. The tail section 139 is configured to mate with a sleeve 160 that circumferentially overlies the corrugated outer conductor 116 of the coaxial cable 110. In some embodiments, the assembly 100 may also include a gasket 170 that circumferentially overlies the corrugated outer conductor 116 of the coaxial cable 110 and resides between the sleeve 160 and the outer jacket 120 of the cable 110. A recess 134a may be located on an outer surface of the outer conductor body 134. The recess 134a may be configured to receive and hold an O-ring or gasket 171.

The insulator 136 is positioned radially outwardly from the post 132a. To further reduce manufacturing costs, in some embodiments, the inner contact 132 and outer connector body 134 of the connector 130 may be made through the process of stamping and rolling sheet metal. Insert molding of the insulator 136 over the inner contact 132 is a common way to produce a low-cost insulator and reduce handling during manufacture of the connector 130. Typically, with a machined inner contact 132, features are machined to allow the insulator 136 to be locked or secured to the inner contact 132 by plastic flowing into these features. In some embodiments of the present invention, the insulator 136 may be insert molded over the inner contact 132. Insulating material 136a (e.g., a polymeric material) is allowed to flow through an axial slot (not shown) from the forming process (i.e., stamping and rolling) and into a lumen of the inner contact 132. This approach allows the insulator 136 to be locked into place with the inner contact 132 without sacrificing electrical performance by adding other features for locking the insulator 136 or the additional cost of creating such features after stamping and rolling the inner contact 132. In some embodiments, the tapered spring basket 133 of the connector 130 may also be formed in the stamping design, thereby eliminating a swaging operation.

The sleeve 160 comprises one or more corrugations 166 that are sized and configured to cooperate or engage with the corrugated profile of the outer conductor 116 of the cable 110, thereby securing the sleeve 160 around the outer conductor 116 of the cable 110 (see, e.g., FIG. 2B). The sleeve 160 radially separates the corrugated outer conductor 116 of the cable 110 from the outer connector body 134 of the connector 130. Similarly, the gasket 170 comprises one or more corrugations 176 that are sized and configured to cooperate or engage with the corrugated profile of the outer conductor 116 of the cable 110, thereby securing the gasket 170 around the outer conductor of the cable 110 (see, e.g., FIG. 2B).

Assembly of the coaxial cable-connector assembly 100 is illustrated in FIGS. 2A-7. Assembly commences with the preparation of the cable 110, which comprises stripping the cable jacket 120 to expose a portion of the outer conductor 116. Additionally, the outer conductor 116 and dielectric layer 114 are stripped to expose the end of the inner conductor 112 (FIGS. 2A-2B). As shown in FIG. 2A, the gasket 170 is threaded onto the helical corrugations 116a of the outer conductor 116 until the gasket 170 is positioned adjacent to the stripped cable jacket 120 (FIG. 2B). Next, the sleeve 160 is threaded onto the outer conductor 116 of the cable 110 until the sleeve 160 is positioned adjacent to the gasket 170 (FIG. 2B). As shown in FIGS. 2A-2B, the sleeve 160 and gasket 170 are positioned on the cable 110 such that an end 116e of the outer conductor 116 is still exposed. Next, as shown in FIGS. 3A-3B, the exposed end 116e of the outer conductor 116 is flared radially outwardly to form a flared end 116f, thereby securing the sleeve 160 and gasket 170 onto the cable 110.

As shown in FIG. 5 and FIG. 6, the connector 130 comprising the outer connector body 134, the inner contact 132, insulator 136, spring basket 133, and coupling nut 180 is then slipped over the prepared end of the cable 110. The connector 130 is slid onto the cable 110 until a shoulder 137 on the inner surface of the outer conductor body 134 contacts the flared end 116f of the outer conductor 116 of the cable 110 and the spring basket 133 engages the inner conductor 112 of the cable 110 (see, e.g., FIG. 6).

As shown in FIG. 7, once the connector 130 is positioned on the cable 110, the connector 130 may be secured to the cable 110 by crimping the tail section 139 of the outer connector body 134 onto the sleeve 160. The outer connector body 134 of the connector 130 is crimped over the sleeve 160 to provide retention and mechanical attachment. The threaded sleeve 160 is pushed forwardly against the flared end 116f of the outer conductor 116 of the cable 110 to form a permanent axial force on the flared end 116f. This forces the flared end 116f against the shoulder 137 of the connector body 134, thereby creating axial electrical contact between the outer conductor 116 of the cable 110 and the connector body 134 of the connector 130. In some embodiments, a press-fit may be applied (e.g., replacing crimping) to create permanent mechanical attachment of the connector 130 to the cable 110. The assembly 100 of the present invention helps to reduce connector costs, as well as helps to alleviate performance concerns such as PIM.

The corrugation fitting profile of the sleeve 160 provides pull-off resistance with the cable 110. This combination locks the connector 130 to the cable 110. Since the sleeve 160 is made of a polymeric material (e.g., plastic), electrical contact between the outer conductor 116 of the cable 110 and the outer connector body 134 is prevented at that location (i.e., no radial electrical contact). Instead, electrical contact is made between the flared end 116f of the outer conductor 116 and the shoulder 137 of the outer conductor body 134, and away from the crimping location. As a result, the electrical contact of the assembly 100 provides a good PIM performance and is isolated from the mechanical attachment.

As shown in FIG. 7 (see also, e.g., FIG. 1A), once the connector 130 is crimped (or press-fit) and secured to the cable 110, the strain relief sleeve 150 is slid forwardly over the connector-cable interface. The strain relief sleeve 150 of the present invention may comprise a spring basket 158 with axial slots 157 at the end of a tubular main body 152. The end of the tubular main body 152 (i.e., spring basket 158) is sized to provide interference with the minimum outer diameter of the cable jacket 120. The slots 157 and flexibility of the polymeric tubular main body 152 allows the spring basket 158 to accommodate a larger cable jacket 120 outer diameter by flexing outward. The length, width, and number of slots 157, as well as the cross-section thickness at the slot root, can be varied to create the proper force against the cable jacket 120. The strain relief sleeve 150 is advanced along the cable 110 and snapped into place on the outer connector body 134 of the connector 130, thereby forming a seal around the crimp and connector-cable interface. In some embodiments, a recess 152a may be located on an outer surface of the strain relieve sleeve 150. The recess 152a may be configured to receive and hold an O-ring or gasket 155.

Referring now to FIGS. 8A-14, an alternative coaxial cable-connector assembly 200 according to embodiments of the present invention is illustrated. Properties and/or features of the coaxial cable-connector assembly 200 may be as described above in reference to the assembly 100 shown in FIGS. 1A-7 and duplicate discussion thereof may be omitted herein for the purposes of discussing FIGS. 8A-14.

As shown in FIGS. 8A-8B, similar to the assembly 100 described above, the assembly 200 includes a coaxial cable 210 and a connector 230 attached to one end thereof. The connection interface between the connector 230 and the coaxial cable 210 is protected by a strain relief sleeve 250. As described in further detail below, the coaxial cable-connector assembly 200 illustrated in FIGS. 8A-14 differs from assembly 100 in that the connector 230 of the assembly 200 includes a collet 239 which is configured to clamp onto a sleeve 260 on the coaxial cable 210 to help secure the connector 230 to the cable 210. The push and clamp design of the coaxial cable-connector assembly 200 helps to reduce attachment costs.

As shown in FIG. 8B (see also, e.g., FIGS. 9A-10B and FIGS. 12A-14), the cable 210 includes an inner conductor 212, a dielectric layer 214 that circumferentially overlies the inner conductor 212, a corrugated outer conductor 216 that circumferentially overlies the dielectric layer 214, and a polymeric cable jacket 220 that circumferentially overlies the outer conductor 216. Similar to the assembly 100 described above, the coaxial cable 210 for the coaxial cable-connector assembly 200 has a helical corrugated outer conductor 216 (see, e.g., FIG. 9A).

The connector 230 includes an inner contact 232, an outer connector body 234, and an insulator 236. The inner contact 232 has a generally cylindrical post 232a and is mounted on, and is in electrical contact with, the inner conductor 212 of the cable 210. In some embodiments, the inner contact 232 is in electrical contact with the inner conductor 212 via a spring basket 233 (see also, e.g., FIGS. 12A-12B, FIG. 13A, and FIG. 14). The insulator 236 is positioned radially outwardly of the post 232a. Similar to connector 130, in some embodiments, to further reduce manufacturing costs, the inner contact 232 and outer connector body 234 of the connector 230 may be made through the process of stamping and rolling. In some embodiments, the insulator 236 may be insert molded over the inner contact 232 to produce a low-cost insulator and reduce handling during manufacture of the connector 230.

The outer connector body 234 of the connector 230 includes a mating end 238 that is configured to mate with the outer conductor body of a mating jack (see also, e.g., FIG. 11). The mating end 238 extends forwardly from one end of the outer connector body 234. In some embodiments, the mating end 238 may be tapered. A flange 242 extends radially outwardly from the outer conductor body 234 and provides a bearing surface for a coupling nut 280.

At its rearward end, the outer connector body 234 has a collet 239 (see also, e.g., FIG. 11). The collet 239 is configured to mate with a sleeve 260 that circumferentially overlies the corrugated outer conductor 216 of the cable 210. As shown in FIG. 11, the collet 239 may comprise a plurality of collet fingers 231 separated by axial slots 236. As discussed in further detail below, the ends of the collet fingers 231 may be bent radially inward to form flanged edges 231e which are configured to engage the sleeve 260. The opening 235 of the collet 239 is sized and configured to allow the connector body 234 to slide over the sleeve 260 such that the connector 230 may be secured to the cable 210.

In some embodiments, the assembly 200 may also include a gasket 270 that circumferentially overlies the corrugated outer conductor 216 of the coaxial cable 210 and resides between the sleeve 260 and the outer jacket 220 of the cable 210. The outer surface of the outer conductor body 234 may comprise one or more recesses 234a, 234b. The recesses 234a, 234b may be configured to receive and hold a respective O-ring or gasket 271, 272.

The sleeve 260 comprises a main body 262 with one or more corrugations 266 along the inner surface that are sized and configured to cooperate or engage with the corrugated profile of the outer conductor 216 of the cable 210, thereby securing the sleeve 260 around the outer conductor 216 of the cable 210 (see, e.g., FIG. 9B). The sleeve 260 radially separates the corrugated outer conductor 216 of the cable from the outer connector body 234 of the connector 230. The sleeve 260 further comprises an annular flange 264 that extends radially outward from the main body 262 of the sleeve 260. The annular flange 264 comprises a tapered surface that corresponds to a tapered inner surface of the flanged edges 231a of the collet fingers 231. The gasket 270 also comprises one or more corrugations 276 that are sized and configured to cooperate or engage with the corrugated profile of the outer conductor 216 of the cable 210, thereby securing the gasket 270 around the outer conductor of the cable 210 (see, e.g., FIG. 9B).

Assembly of the coaxial cable-connector assembly 200 is illustrated in FIGS. 9A-14. Assembly commences with the preparation of the cable 210, which comprises stripping the cable jacket 220 to expose a portion of the outer conductor 216. Additionally, the outer conductor 216 and dielectric layer 214 are stripped to expose the end of the inner conductor 212 (FIGS. 9A-9B). As shown in FIG. 9A, the gasket 270 is threaded onto the helical corrugations 216a of the outer conductor 216 until the gasket 270 is positioned adjacent to the stripped cable jacket 220 (FIG. 9B) Next, the sleeve 260 is threaded onto the outer conductor 216 of the cable 210 until the sleeve 260 is positioned adjacent to the gasket 270 (FIG. 9B). As shown in FIGS. 9A-9B, the sleeve 260 and gasket 270 are positioned on the cable 210 such that the end 216e of the outer conductor 216 is still exposed. Next, as shown in FIGS. 10A-10B, the exposed end 216e of the outer conductor 216 is flared radially outwardly to form a flared end 216f (i.e., prepared end), thereby securing the sleeve 260 and gasket 270 onto the cable 210.

As shown in FIG. 12A, FIGS. 13A-13B, and FIG. 14, the connector 230 comprising the outer connector body 234, the inner contact 232, insulator 236, spring basket 233, and coupling nut 280 is then slipped over the prepared end of the cable 210. The connector 230 is slid onto the cable 210 until a shoulder 237 on the inner surface of the outer conductor body 234 contacts the flared end 216f of the outer conductor 216 of the cable 210 and the spring basket 233 engages the inner conductor 212 of the cable 210 (see, e.g., FIG. 6). As shown in FIGS. 12A-12B, the opening 235 of the collet 239 allows the end of the connector body 234 to slide onto the coaxial cable 210 over the sleeve 260. As shown in FIG. 12B, when the connector 230 and cable 210 are engaged, the flanged edges 231e of the collet fingers 231 extend past the annular flange 264 of the sleeve 260 leaving a gap G between the shoulder 237 of the outer connector body 234 and the flared end 216f of the outer conductor 216 of the cable 210.

Once the connector 230 is positioned on the cable 210, the connector 230 may be secured to the cable 210 by crimping the collet end 239 of the outer connector body 234 onto the sleeve 260. The radial squeeze (or crimp) on the outer surface of the collet 239 forces the tapered surface of the flanged edges 231e of the collet fingers 231 to slide against the tapered surface of the flange 264 of the sleeve 260, thereby generating an axial force on the main body 262 of the sleeve 260. The axial force drives the sleeve 260 into the shoulder 237 of the connector body 234 and against the flared end 216f of the outer conductor 216 of the cable 210 residing therebetween which closes the gap G (see, e.g., FIG. 13A). Crimping of the outer connector body 234 of the connector 230 onto the sleeve 260 provides retention and mechanical attachment. As shown in FIG. 13A, the threaded sleeve 260 presses into the shoulder 237 of the outer connector body 234 to form a permanent axial force on the flared end 216f of the outer conductor 216 of the cable 210 located therebetween.

FIG. 13B is a perspective view of the assembly 200 with the collet 239 of the outer conductor body 234 crimped over the sleeve 260 and onto the cable 210. The assembly 200 of the present invention helps to reduce connector costs, as well as helps to alleviate performance concerns such as PIM. Since the sleeve 260 is made of a polymeric material (e.g., plastic), electrical contact between the outer conductor 216 of the cable 210 and the outer connector body 234 is prevented at that location. Instead, electrical contact is made between the flared end 216f of the outer conductor 216 and the shoulder 237 of the outer conductor body 234, and away from the crimping location. As a result, the radial contact of the assembly 200 provides good PIM performance and is isolated from the mechanical attachment.

As shown in FIG. 14 (see also, e.g., FIG. 8A), once the connector 230 is crimped and secured to the cable 210, the strain relief sleeve 250 is slid forwardly over the connector-cable interface. The strain relief sleeve 250 of the present invention may comprise a spring basket 258 with axial slots 257 at the end of a tubular main body 252. The end of the tubular main body 252 (i.e., spring basket 258) is sized to provide interference with the minimum outer diameter of the cable jacket 220. The slots 257 and flexibility of the polymeric tubular main body 252 allows the spring basket 258 to accommodate a larger cable jacket 220 outer diameter by flexing outward. The length, width, and number of slots 257, as well as the cross-section thickness at the slot root, can be varied to create the proper force against the cable jacket 220. The strain relief sleeve 250 is advanced along the cable 210 and snapped into place on the outer connector body 234 of the connector 230, thereby forming a seal around the crimp and connector-cable interface.

Referring now to FIGS. 15A-20, an alternative coaxial cable-connector assembly 300 according to embodiments of the present invention is illustrated. Properties and/or features of the coaxial cable-connector assembly 300 may be as described above in reference to the assemblies 100, 200 shown in FIGS. 1A-7 and FIGS. 8A-14, and duplicate discussion thereof may be omitted herein for the purposes of discussing FIGS. 15A-20.

As shown in FIGS. 15A-15B, similar to the assemblies 100, 200 describe herein, the assembly 300 includes a coaxial cable 310 and a connector 330 attached to one end thereof. The connection interface between the connector 330 and the coaxial cable 310 is protected by a strain relief sleeve 350. As described in further detail below, the coaxial cable-connector assembly 300 illustrated in FIGS. 15A-20 differs from assemblies 100, 200 described herein in that the coaxial cable 310 has a annular corrugated outer conductor 316 and the connector 330 of the assembly 300 includes a collet 339 which is configured to clamp onto an alternative sleeve 360 that is configured to engage the annular corrugated outer conductor 316 of the cable 310 to help secure the connector 330 to the cable 310. Similar to assembly 200, the push and clamp design of the coaxial cable-connector assembly 300 of the present invention helps to reduce attachment costs.

As shown in FIG. 15B (see also, e.g., FIGS. 16A-16B and FIGS. 18A-20), the cable 310 includes an inner conductor 312, a dielectric layer 314 that circumferentially overlies the inner conductor 312, a corrugated outer conductor 316 that circumferentially overlies the dielectric layer 314, and a polymeric cable jacket 320 that circumferentially overlies the outer conductor 316. As discussed above, the coaxial cable 310 for the assembly 300 has an annular corrugated outer conductor 316 (see, e.g., FIG. 1613).

The connector 330 includes an inner contact 332, an outer connector body 334, and an insulator 336. The inner contact 332 has a generally cylindrical post 332a and is mounted on, and is in electrical contact with, the inner conductor 312 of the cable 310. In some embodiments, the inner contact 332 is in electrical contact with the inner conductor 312 via a spring basket 333 (see also, e.g., FIG. 19A and FIG. 20). The insulator 336 is positioned radially outwardly of the post 332a. Similar to other connectors 130, 230 described herein, in some embodiments, to further reduce manufacturing costs, the inner contact 332 and outer connector body 334 of the connector 330 may be made through the process of stamping and rolling. In some embodiments, the insulator 336 may be insert molded over the inner contact 332 to produce a low-cost insulator and reduce handling during manufacture of the connector 330.

The outer connector body 334 includes a mating end 338 that is configured to mate with the outer conductor body of a mating jack (see also, e.g., FIG. 17). The mating end 338 extends forwardly from one end of the outer connector body 334. In some embodiments, the mating end 338 may be tapered. A flange 342 extends radially outwardly from the outer conductor body 334 and provides a bearing surface for a coupling nut 380. Similar to the outer connector body 234 of the assembly 200 described herein, at its rearward end, the outer connector body 334 includes a collet 339 (see also, e.g., FIG. 17). The collet 339 is configured to mate with a sleeve 360 that circumferentially overlies the corrugated outer conductor 316 of the cable 310. As shown in FIG. 17, the collet 339 may comprise a plurality of collet fingers 331 separated by axial slots 336. As discussed in further detail below, the ends of the collet fingers 331 are bent radially inward to form flanged edges 331e which are configured to engage the sleeve 360. The opening 335 of the collet 339 is sized and configured to allow the end of the connector body 334 slide onto a cable 310 with a sleeve 360 prior to the connector 330 being secured to the cable 310.

In some embodiments, the assembly 300 may also include a gasket or O-ring 370 that fits in one of the corrugations 316a of the outer conductor 316 of the cable 310 and resides between the sleeve 360 and the outer jacket 320 of the cable 310. The outer surface of the outer conductor body 334 may comprise one or more recesses 334a. The recess(es) 334a may be configured to receive and hold a respective O-ring or gasket 371 (see, e.g., FIGS. 19A and 20).

As shown in FIGS. 16A-16B, the sleeve 360 comprises a plurality of fingers 362 extending forwardly from an annular flange 364 that extends radially outward from the sleeve 360. The sleeve 360 radially separates the outer conductor 316 of the cable 310 from the outer connector body 334 of the connector 330. The end of each finger 362 has a protrusion 363 extending radially outward therefrom. The annular flange 364 comprises a tapered surface that corresponds to a tapered inner surface of flanged edges 331e of the collet fingers 331 of the outer conductor body 334.

Assembly of the coaxial cable-connector assembly 300 is illustrated in FIGS. 16A-20. Assembly commences with the preparation of the cable 310, which comprises stripping the cable jacket 320 to expose a portion of the outer conductor 316. Additionally, the outer conductor 316 and dielectric layer 314 are stripped to expose the end of the inner conductor 312 (FIGS. 16A-16B). As shown in FIGS. 16A-16B, the O-ring 370 is fit into one of the corrugations 316a of the outer conductor 316 positioned adjacent to the stripped cable jacket 320. Next, the sleeve 360 is slid onto the outer conductor 316 of the cable 310 until the sleeve 360 is positioned adjacent to the O-ring 370. Next, the end of the outer conductor 316 is flared radially outwardly to form a flared end 316f, thereby securing the sleeve 360 onto the cable 310.

As shown in FIGS. 18A-20, the connector 330 comprising the outer connector body 334, the inner contact 332, insulator 336, spring basket 333, and coupling nut 380 is then slipped over the prepared end of the cable 310. The connector 330 is slid onto the cable 310 until a shoulder 337 on the inner surface of the outer conductor body 334 contacts the flared end 316f of the outer conductor 316 of the cable 310 and spring basket 333 engages the inner conductor 312 of the cable 310 (see, e.g., FIGS. 18A-18B and FIG. 19). As shown in FIGS. 18A-18C, the opening 335 of the collet 339 allows the end of the connector body 334 to slide onto a cable 310 over the sleeve 360. As shown in FIG. 18B, when the connector 330 and cable 310 are engaged, the flanged edges 331e of the collet fingers 331 extend past the flange 364 of the sleeve 360 and there is a gap G2 between the protruded ends 363 of the sleeve 360 and the flared end 216f of the outer conductor 316 of the cable 310.

Once the connector 330 is positioned on the cable 310, the connector 330 may be secured to the cable 310 by crimping the collet 339 of the outer connector body 334 onto the sleeve 360. The radial squeeze (or crimp) on the outer surface of the collet 339 forces the tapered surface of the flanged edges 331e of the collet fingers 331 to slide against the tapered surface of the flange 364 of the sleeve 360 (FIG. 18C), thereby generating an axial force driving the protruded ends 363 of the sleeve 360 into contact with the shoulder 337 of the connector body 334 and against the flared end 316f of the outer conductor 316 of the cable 310 residing therebetween, closing the gap G2 (see, e.g., FIG. 19A). The crimping of the outer connector body 334 of the connector 330 over the sleeve 360 provides retention and mechanical attachment. As shown in FIG. 19A, the sleeve 360 presses into the shoulder 337 of the outer connector body 334 to form a permanent axial force on the flared end 316f of the outer conductor 316 of the cable 310.

FIG. 19B is a side view of the assembly 300 with the collet 339 of the outer conductor body 334 crimped over the sleeve 360 and onto the cable 310. The assembly 300 of the present invention helps to reduce connector costs, as well as helps to alleviate performance concerns such as PIM. Since the sleeve 360 is made of a polymeric material (e.g., plastic), electrical contact between the outer conductor 316 of the cable 310 and the outer connector body 334 is prevented at that location. Instead, electrical contact is made between the flared end 316f of the outer conductor 316 and the shoulder 337 of the outer conductor body 334, and away from the crimping location. As a result, the radial contact of the assembly 300 provides a good PIM performance and is isolated from the mechanical attachment.

As shown in FIG. 20 (see also, e.g., FIG. 15A), once the connector 330 is crimped and secured to the cable 310, the strain relief sleeve 350 is slid forwardly over the connector-cable interface. Similar to the strain relief sleeves 150, 250 for the assemblies 100, 200 described herein, the strain relief sleeve 350 may comprise a spring basket 358 with axial slots 357 at the end of a tubular main body 352. The end of the tubular main body 352 (i.e., spring basket 358) is sized to provide interference with the minimum outer diameter of the cable jacket 320. The slots 357 and flexibility of the polymeric tubular main body 352 allows the spring basket 358 to accommodate a larger cable jacket 320 outer diameter by flexing outward. The length, width, and number of slots 357, as well as the cross-section thickness at the slot root, can be varied to create the proper force against the cable jacket 320. The strain relief sleeve 350 is advanced along the cable 310 and snapped into place on the outer connector body 334 of the connector 330, thereby forming a seal around the crimp and connector-cable interface.

Referring now to FIGS. 21A-24, an alternative coaxial cable-connector assembly 400 according to embodiments of the present invention is illustrated. Properties and/or features of the coaxial cable-connector assembly 400 may be as described above in reference to the assemblies 100-300 shown in FIGS. 1A-20, and duplicate discussion thereof may be omitted herein for the purposes of discussing FIGS. 21A-23C.

As shown in FIGS. 21A-21B, similar to the assemblies 100-300 describe above, the assembly 400 includes a coaxial cable 410 and a connector 430 attached to one end thereof. The connection interface between the connector 430 and the coaxial cable 410 is protected by a strain relief sleeve 450. Similar to assembly 300 described herein, the coaxial cable 410 of assembly 400 has an annular corrugated outer conductor 316. As described in further detail below, the coaxial cable-connector assembly 400 illustrated in FIGS. 21A-23C differs from the other assemblies 100-300 described herein in that the assembly 400 includes a collet 339 which is configured to be swaged onto an alternative sleeve 460 such that the sleeve 460 engages the annular corrugated outer conductor 416 of the cable 410 to help secure the connector 430 to the cable 410. The push and swage design of the assembly 400 of the present invention helps to reduce attachment costs.

As shown in FIG. 21B (see also, e.g., FIGS. 22A-23B and FIG. 24), the cable 410 includes an inner conductor 412, a dielectric layer 414 that circumferentially overlies the inner conductor 412, a corrugated outer conductor 416 that circumferentially overlies the dielectric layer 414, and a polymeric cable jacket 420 that circumferentially overlies the outer conductor 416. As discussed above, the cable 410 for the assembly 400 has an annular corrugated outer conductor 416 (see, e.g., FIG. 22A).

The connector 430 includes an inner contact 432, an outer connector body 434, and an insulator 436. The inner contact 432 has a generally cylindrical post 432a and is mounted on, and is in electrical contact with, the inner conductor 412 of the cable 410. In some embodiments, the inner contact 432 is in electrical contact with the inner conductor 412 via a spring basket 433 (see also, e.g., FIGS. 23A-23B and FIG. 24). The insulator 436 is positioned radially outwardly of the post 432a. In some embodiments, to further reduce manufacturing costs, the inner contact 432 and outer connector body 434 of the connector 430 may be made through the process of stamping and rolling. In some embodiments, the insulator 436 may be insert molded over the inner contact 432 to produce a low-cost insulator and reduce handling during manufacture of the connector 430.

The outer connector body 434 includes a mating end 438 that is configured to mate with the outer conductor body of a mating jack. The mating end 438 extends forwardly from one end of the outer connector body 434. In some embodiments, the mating end 438 may be tapered. A flange 442 extends radially outwardly from the outer conductor body 434 and provides a bearing surface for a coupling nut 480. At its rearward end, the outer connector body 434 has a tail section 439 (see also, e.g., FIGS. 23A-23B). The tail section 439 is configured to mate with a sleeve (or collet) 460 that circumferentially overlies the corrugated outer conductor 416 of the cable 410. The tail section 439 is sized and configured to slide onto a cable 410 over a sleeve (or collet) 460 prior to the connector 430 being secured to the cable 410.

In some embodiments, the assembly 400 may also include a gasket or O-ring 470 that fits in one of the corrugations 416a of the outer conductor 416 of the cable 410 and resides between the sleeve 460 and the outer jacket 420 of the cable 410. The outer surface of the outer conductor body 434 may comprise one or more recesses 434a. The recess(es) 434a may be configured to receive and hold a respective O-ring or gasket 471 (see, e.g., FIGS. 23D and 24).

As shown in FIGS. 22A-22B, the sleeve 460 comprises a plurality of fingers 462 extending forwardly from an annular flange 464 that extends radially outward from the sleeve 460. The sleeve 460 radially separates the outer conductor 416 of the cable 410 from the outer connector body 434 of the connector 430. The end of each finger 462 has a protrusion 463 extending radially outward therefrom. The annular flange 464 comprises a recess 464a (see, e.g., FIG. 22B). As discussed in further detail below, in some embodiments, the recess 464a may be configured to engage at least a portion of the end 439e of the tail section 439 of the connector body 434 to secure the connector 430 to the cable 410.

Assembly of the coaxial cable-connector assembly 400 is illustrated in FIGS. 22A-24. Assembly commences with the preparation of the cable 410, which comprises stripping the cable jacket 420 to expose a portion of the outer conductor 416. Additionally, the outer conductor 416 and dielectric layer 414 are stripped to expose the end of the inner conductor 412 (FIGS. 22A-22B). As shown in FIGS. 22A-22B, the O-ring 470 is fit into one of the corrugations 416a of the outer conductor 416 positioned adjacent to the stripped cable jacket 420. Next, the sleeve 460 is slid onto the outer conductor 416 of the cable 410 until the sleeve 460 is positioned adjacent to the O-ring 470. Next, the end of the outer conductor 416 is flared radially outwardly to form a flared end 416f, thereby securing the sleeve 460 onto the cable 410.

As shown in FIGS. 23A-230, the connector 430 comprising the outer connector body 434, the inner contact 432, insulator 436, spring basket 433, and coupling nut 480 is then slipped over the prepared end of the cable 410. The connector 430 is slid onto the cable 410 until a shoulder 437 on the inner surface of the outer conductor body 434 contacts the flared end 416f of the outer conductor 416 of the cable 410 and spring basket 433 engages the inner conductor 412 of the cable 410. As shown in FIGS. 23A-23C, when the connector 430 and cable 410 are engaged, the free end 439e of the tail section 439 of the connector body 434 extends past the annular flange 464 of the sleeve 460 and the protruded end 463 of the sleeve 460 pushes the flared end 416f of the outer conductor 416 of the cable 410 in contact with the shoulder 437 of the connector body 434.

Once the connector 430 is positioned on the cable 410, the connector 430 may be secured to the cable 410 by swaging the free end 439e of the tail section 339 of the outer connector body 434 onto the sleeve 460. The connector 430 and cable 410 should be held under axial force during swaging. The radial squeeze (or swage) on the outer surface of the tail section 439 forces at least a portion of the free end 439e to deform into the recess 464a of the annular flange 464 of the sleeve 460 (see, e.g., FIG. 23C). The swaging generates an axial force which drives the protruded ends 463 of the sleeve 460 in contact with the shoulder 437 of the connector body 434 and against the flared end 416f of the outer conductor 416 of the cable 410 residing therebetween (see, e.g., FIG. 23B). The swaging of the outer connector body 434 of the connector 430 over the sleeve 460 provides retention and mechanical attachment at a retention point RP between the deformed inner surface of the free end 439e of the connector body 434 and the edge of the recess 464a of the sleeve 460 (see, e.g., FIG. 23C). In addition, as shown in FIG. 23B, the sleeve 460 presses in contact with the shoulder 437 of the outer connector body 434 to form a permanent axial force on the flared end 416f of the outer conductor 416 of the cable 410.

FIG. 23D is a side view of the assembly 400 with the tail section 439 of the outer conductor body 434 swaged over the sleeve 460 and onto the cable 410. The assembly 400 of the present invention helps to reduce connector costs, as well as helps to alleviate performance concerns such as PIM. Since the sleeve 460 is made of a polymeric material (e.g., plastic), electrical contact between the outer conductor 416 of the cable 410 and the outer connector body 434 is prevented at that location. Instead, electrical contact is made between the flared end 416f of the outer conductor 416 and the shoulder 437 of the outer conductor body 434, and away from the swaging location. As a result, the radial contact of the assembly 400 provides a good PIM performance and is isolated from the mechanical attachment.

As shown in FIG. 24 (see also, e.g., FIGS. 21A-2113), once the connector 430 is swaged and secured to the cable 410, the strain relief sleeve 450 is slid forwardly over the connector-cable interface. Similar to the strain relief sleeves 150-350 for the assemblies 100-300 described herein, the strain relief sleeve 450 may comprise a spring basket 458 with axial slots 457 at the end of a tubular main body 452. The end of the tubular main body 452 (i.e., spring basket 458) is sized to provide interference with the minimum outer diameter of the cable jacket 420. The slots 457 and flexibility of the polymeric tubular main body 452 allows the spring basket 458 to accommodate a larger cable jacket 420 outer diameter by flexing outward. The length, width, and number of slots 457, as well as the cross-section thickness at the slot root, can be varied to create the proper force against the cable jacket 420. The strain relief sleeve 450 is advanced along the cable 410 and snapped into place on the outer connector body 434 of the connector 430, thereby forming a seal around the crimp and connector-cable interface.

Referring now to FIGS. 25A-29, an alternative coaxial cable-connector assembly 500 according to embodiments of the present invention is illustrated. Properties and/or features of the coaxial cable-connector assembly 500 may be as described above in reference to the assemblies 100-400 shown in FIGS. 1A-24, and duplicate discussion thereof may be omitted herein for the purposes of discussing FIGS. 25A-29.

As shown in FIGS. 25A-25B, similar to the assemblies 100-400 describe above, the assembly 500 includes a coaxial cable 510 and a connector 530 attached to one end thereof. The connection interface between the connector 530 and the coaxial cable 510 is protected by a strain relief sleeve 550. Similar to assemblies 100, 200, the coaxial cable 510 of assembly 500 has a helical corrugated outer conductor 516. As described in further detail below, the coaxial cable-connector assembly 500 illustrated in FIGS. 25A-29 differs from assemblies 100-400 described herein in the way that the tail section 539 of the connector body 534 of the assembly 500 is configured to be secured onto the sleeve 560. The push and swage design of the assembly 500 of the present invention helps to reduce attachment costs.

As shown in FIG. 25B (see also, e.g., FIGS. 26A-28B and FIG. 29), the cable 510 includes an inner conductor 512, a dielectric layer 514 that circumferentially overlies the inner conductor 512, a corrugated outer conductor 516 that circumferentially overlies the dielectric layer 514, and a polymeric cable jacket 520 that circumferentially overlies the outer conductor 516. As discussed above, the coaxial cable 510 for the assembly 500 has a helical corrugated outer conductor 516 (see, e.g., FIG. 26A).

The connector 530 includes an inner contact 532, an outer connector body 534, and an insulator 536. The inner contact 532 has a generally cylindrical post 532a and is mounted on, and is in electrical contact with, the inner conductor 512 of the cable 510. In some embodiments, the inner contact 532 is in electrical contact with the inner conductor 512 via a spring basket 533 (see also, e.g., FIGS. 28A-28B and FIG. 29). In some embodiments, to further reduce manufacturing costs, the inner contact 532 and outer connector body 534 of the connector 530 may be made through the process of stamping and rolling. In some embodiments, the insulator 536 may be insert molded over the inner contact 532 to produce a low-cost insulator and reduce handling during manufacture of the connector 530.

The outer connector body 534 includes a mating end 538 that is configured to mate with the outer conductor body of a mating jack. The mating end 538 extends forwardly from one end of the outer connector body 534. In some embodiments, the mating end 538 may be tapered. A flange 542 extends radially outwardly from the outer conductor body 534 and provides a bearing surface for a coupling nut 580. At its rearward end, the outer connector body 534 has a tail section 539 (see also, e.g., FIGS. 28A-28C). The tail section 539 is configured to mate with a sleeve 560 that circumferentially overlies the corrugated outer conductor 516 of the cable 510. The tail section 539 is sized and configured to slide over a sleeve 560 onto a cable 510 prior to the connector 530 being secured to the cable 510.

In some embodiments, the assembly 500 may also include a gasket 570 that is configured to be threaded onto the helical corrugated outer conductor 516 of the cable 510 and resides between the sleeve 560 and the outer jacket 520 of the cable 510. The outer surface of the outer conductor body 534 may comprise one or more recesses 534a. The recess(es) 534a may be configured to receive and hold a respective O-ring or gasket 571 (see, e.g., FIG. 25B and FIGS. 28A-28B).

As shown in FIGS. 26A-28C, the sleeve 560 comprises a main body 562 having an annular recess 562a. The sleeve 560 radially separates the corrugated outer conductor 516 of the cable 510 from the outer connector body 534 of the connector 530. As discussed in further detail below, in some embodiments, the recess 562a may be configured to engage at least a portion of the tail section 539 of the connector body 534 to secure the connector 530 to the cable 510 (i.e., when swaged).

Assembly of the coaxial cable-connector assembly 500 is illustrated in FIGS. 26A-29. Assembly commences with the preparation of the cable 510, which comprises stripping the cable jacket 520 to expose a portion of the outer conductor 516. Additionally, the outer conductor 516 and dielectric layer 514 are stripped to expose the end of the inner conductor 512 (FIGS. 26A-26B). As shown in FIG. 26A, the gasket 570 is threaded onto the helical corrugations 516a of the outer conductor 516 until the gasket 570 is positioned adjacent to the stripped cable jacket 520. Next, the sleeve 560 is threaded onto the outer conductor 516 of the cable 510 until the sleeve 560 is positioned adjacent to the gasket 570. As shown in FIGS. 26A-26B, the sleeve 560 and gasket 570 are positioned on the cable 510 such that the end 516e of the outer conductor 516 is still exposed. Next, as shown in FIGS. 27A-27B, the exposed end 516e of the outer conductor 516 is flared radially outwardly to form a flared end 516f, thereby securing the sleeve 560 and gasket 570 onto the cable 510.

As shown in FIGS. 28A-28C, the connector 530 comprising the outer connector body 534, the inner contact 532, insulator 536, spring basket 533, and coupling nut 580 is then slipped over the prepared end of the cable 510. The connector 530 is slid onto the cable 510 until a shoulder 537 on the inner surface of the outer conductor body 534 contacts the flared end 516f of the outer conductor 516 of the cable 510 and spring basket 533 engages the inner conductor 512 of the cable 510. As shown in FIGS. 28A-28B, when the connector 530 and cable 510 are engaged, the tail section 539 of the connector body 534 extends over the sleeve 560.

Once the connector 530 is positioned on the cable 510, the connector 530 may be secured to the cable 510 by swaging the tail section 539 of the outer connector body 534 onto the sleeve 560. The connector 530 and coaxial cable 510 should be held under axial force during swaging. The radial squeeze (or swage) on the outer surface of the tail section 539 forces at least a portion 539a of the tail section 539 to deform into the recess 562a of the sleeve 560 (see, e.g., FIG. 28C). The swaging of the outer connector body 534 of the connector 530 over the sleeve 560 provides retention and mechanical attachment at a retention point RP2 between the deformed inner surface of the tail section 539 of the connector body 434 and the edge of the recess 562a of the sleeve 560 (see, e.g., FIG. 28C). In addition, as shown in FIG. 28A-28B, the sleeve 560 presses into the shoulder 537 of the outer connector body 534 to form a permanent axial force on the flared end 516f of the outer conductor 516 of the cable 510 residing therebetween.

FIG. 28D is a side view of assembly 500 with the tail section 539 of the outer conductor body 534 swaged over the sleeve 560 and onto the cable 510. The assembly 500 of the present invention helps to reduce connector costs, as well as helps to alleviate performance concerns such as PIM. Since the sleeve 560 is made of a polymeric material (e.g., plastic), electrical contact between the outer conductor 516 of the cable 510 and the outer connector body 534 is prevented at that location. Instead, electrical contact is made between the flared end 516f of the outer conductor 516 and the shoulder 537 of the outer conductor body 534, and away from the swaging location. As a result, the radial contact of the assembly 500 provides good PIM performance and is isolated from the mechanical attachment.

As shown in FIG. 29 (see also, e.g., FIGS. 25A-25B), once the connector 530 is swaged and secured to the cable 510, the strain relief sleeve 550 is slid forwardly over the connector-cable interface. The strain relief sleeve 550 is similar to the strain relief sleeves 150-450 for the assemblies 100-400 described herein.

Referring now to FIGS. 30A-30B, an alternative coaxial cable-connector assembly 600 according to embodiments of the present invention is illustrated. Properties and/or features of the coaxial cable-connector assembly 600 may be as described above in reference to the assemblies 100-500 shown in FIGS. 1A-29, and duplicate discussion thereof may be omitted herein for the purposes of discussing FIGS. 30A-30B.

As shown in FIGS. 30A-30B, similar to the assemblies 100-500 describe above, the assembly 600 includes a coaxial cable 610 and a connector 630 attached to one end thereof. The connection interface between the connector 630 and the coaxial cable 610 is protected by a strain relief sleeve 650. Similar to assemblies 100, 200, 500 the coaxial cable 610 of assembly 600 has a helical corrugated outer conductor 616. As described in further detail below, the coaxial cable-connector assembly 600 illustrated in FIGS. 30A-30B differs from assemblies 100-500 described herein in the way that the tail section 639 of the connector body 634 of the assembly 600 is configured to be secured onto the sleeve 660. The push and swage design of the assembly 600 of the present invention helps to reduce attachment costs.

As shown in FIG. 30B, the cable 610 includes an inner conductor 612, a dielectric layer 614 that circumferentially overlies the inner conductor 612, a corrugated outer conductor 616 that circumferentially overlies the dielectric layer 614, and a polymeric cable jacket 620 that circumferentially overlies the outer conductor 616. As discussed above, the cable 610 for the assembly 600 has a helical corrugated outer conductor 616.

The connector 630 includes an inner contact 632, an outer connector body 634, and an insulator 636. The inner contact 632 has a generally cylindrical post 632a and is mounted on, and is in electrical contact with, the inner conductor 612 of the cable 610. In some embodiments, the inner contact 632 is in electrical contact with the inner conductor 612 via a spring basket 633. In some embodiments, to further reduce manufacturing costs, the inner contact 632 and outer connector body 634 of the connector 630 may be made through the process of stamping and rolling. In some embodiments, the insulator 636 may be insert molded over the inner contact 632 to produce a low-cost insulator and reduce handling during manufacture of the connector 630.

The outer connector body 634 includes a mating end 638 that is configured to mate with the outer conductor body of a mating jack. The mating end 638 extends forwardly from one end of the outer connector body 634. In some embodiments, the mating end 638 may be tapered. A flange 642 extends radially outwardly from the outer conductor body 634 and provides a bearing surface for a coupling nut 680. At its rearward end, the outer connector body 634 has a tail section 639. The tail section 639 is configured to mate with a sleeve 660 that circumferentially overlies the corrugated outer conductor 616 of the coaxial cable 610. The tail section 639 is sized and configured to slide onto a coaxial cable 610 with a sleeve 660 prior to the connector 630 being secured to the coaxial cable 610.

In some embodiments, the assembly 600 may also include a gasket 670 that is configured to be threaded onto the outer conductor 616 of the cable 610 and resides between the sleeve 660 and the outer jacket 620 of the cable 610. The outer surface of the outer conductor body 634 may comprise one or more recesses 634a. The recess(es) 634a may be configured to receive and hold a respective O-ring or gasket 671. The sleeve 660 radially separates the corrugated outer conductor 616 of the cable 610 from the outer connector body 634 of the connector 630.

Similar to other assemblies 100-500 described herein, assembly of the coaxial cable-connector assembly 600 commences with the preparation of the cable 610, which comprises stripping the cable jacket 620 to expose a portion of the outer conductor 616. Additionally, the outer conductor 616 and dielectric layer 614 are stripped to expose the end of the inner conductor 612. The gasket 670 is threaded onto the helical corrugations 616a of the outer conductor 616 until the gasket 670 is positioned adjacent to the stripped cable jacket 620. Next, the sleeve 660 is threaded onto the outer conductor 616 of the cable 610.

Still referring to FIG. 30B, the connector 630 comprising the outer connector body 634, the inner contact 632, insulator 636, spring basket 633, and coupling nut 680 is then slipped over the prepared end of the cable 610. The connector 630 is slid onto the cable 610 until a shoulder 637 on the inner surface of the outer conductor body 634 contacts the prepared end 616e of the outer conductor 616 of the cable 610 and spring basket 633 engages the inner conductor 612 of the cable 610. When the connector 630 and cable 610 are engaged, the tail section 639 of the connector body 634 extends over at least a portion of the sleeve 660.

Once the connector 630 is positioned on the cable 610, the connector 630 may be secured to the cable 610 by crimping at least a portion of the tail section 639 of the outer connector body 634 onto the sleeve 660. The connector 630 and cable 610 should be held under axial force during crimping. The radial squeeze (or crimp) on the outer surface of the tail section 639 forces the tail section 639 to engage the sleeve 660. In some embodiments, a hex shape or other axisymmetric crimp may be used to help prevent rotation of the cable 610 within the sleeve 660. The crimping of the outer connector body 634 of the connector 630 over the sleeve 660 provides retention and mechanical attachment. A permanent axial force is formed on the prepared end 616e of the outer conductor 616 of the cable 610 against the shoulder 637 of the connector body 634. In some embodiments, a press-fit may be applied (e.g., replacing crimping) to create permanent mechanical attachment of the connector 630 to the cable 610.

Once the connector 630 is crimped (or press-fit) and secured to the cable 610, the strain relief sleeve 650 is slid forwardly over the connector-cable interface (see, e.g., FIG. 30A). The strain relief sleeve 650 is similar to the strain relief sleeves 150-550 for the assemblies 100-500 described herein.

Referring now to FIGS. 31A-31C, an alternative coaxial cable-connector assembly 700 according to embodiments of the present invention is illustrated. Properties and/or features of the coaxial cable-connector assembly 700 may be as described above in reference to the assemblies 100-600 shown in FIGS. 1A-30B, and duplicate discussion thereof may be omitted herein for the purposes of discussing FIGS. 31A-31C.

As shown in FIGS. 31A-31B, similar to the assemblies 100-600 describe above, the assembly 700 includes a coaxial cable 710 and a connector 730 attached to one end thereof. The connection interface between the connector 730 and the coaxial cable 710 may be protected by a strain relief sleeve (not shown). Similar to assemblies 100, 200, 500, 600 the coaxial cable 710 of assembly 700 has a helical corrugated outer conductor 716. As described in further detail below, the coaxial cable-connector assembly 700 illustrated in FIGS. 31A-31B differs from assemblies 100-600 described herein in the way that the tail section 739 of the connector body 734 of the assembly 700 is configured to be secured to an alternative sleeve 760 (FIG. 31C). The push and crimp design of the assembly 700 of the present invention helps to reduce attachment costs.

As shown in FIG. 31B, the cable 710 includes an inner conductor 712, a dielectric layer 714 that circumferentially overlies the inner conductor 712, a corrugated outer conductor 716 that circumferentially overlies the dielectric layer 714, and a polymeric cable jacket 720 that circumferentially overlies the outer conductor 716. As discussed above, the coaxial cable 710 for the assembly 700 has a helical corrugated outer conductor 716.

The connector 730 includes an inner contact 732, an outer connector body 734, and an insulator 736. The inner contact 732 has a generally cylindrical post 732a and is mounted on, and is in electrical contact with, the inner conductor 712 of the cable 710. In some embodiments, the inner contact 732 is in electrical contact with the inner conductor 712 via a spring basket 733. In some embodiments, to further reduce manufacturing costs, the inner contact 732 and outer connector body 734 of the connector 730 may be made through the process of stamping and rolling. In some embodiments, the insulator 736 may be insert molded over the inner contact 732 to produce a low-cost insulator and reduce handling during manufacture of the connector 730.

The outer connector body 734 includes a mating end 738 that is configured to mate with the outer conductor body of a mating jack. The mating end 738 extends forwardly from one end of the outer connector body 734. In some embodiments, the mating end 738 may be tapered. A flange 742 extends radially outwardly from the outer conductor body 734 and provides a bearing surface for a coupling nut 780. At its rearward end, the outer connector body 734 has a tail section 739. The tail section 739 is configured to mate with a sleeve 760 that circumferentially overlies the corrugated outer conductor 716 of the coaxial cable 710. As shown in FIG. 31B, as discussed in further detail below, in some embodiments, the inner surface of the tail section 739 may have a tapered section 739a which corresponds to a tapered surface 762a of the sleeve 760 (see also, e.g., FIG. 31C). The tail section 739 is sized and configured to slide onto a coaxial cable 710 with a sleeve 760 prior to the connector 730 being secured to the coaxial cable 710.

In some embodiments, the assembly 700 may also include a gasket 770 that is configured to be threaded onto the helical corrugated outer conductor 716 of the coaxial cable 710 and resides between the sleeve 760 and the outer jacket 720 of the cable 710. The outer surface of the outer conductor body 734 may comprise one or more recesses 734a. The recess(es) 734a may be configured to receive and hold a respective O-ring or gasket 771. The sleeve 760 radially separates the corrugated outer conductor 716 of the cable 710 from the outer connector body 734 of the connector 730.

Similar to other assemblies 100-600 described herein, assembly of the coaxial cable-connector assembly 700 commences with the preparation of the cable 710, which comprises stripping the cable jacket 720 to expose a portion of the outer conductor 716. Additionally, the outer conductor 716 and dielectric layer 714 are stripped to expose the end of the inner conductor 712. The gasket 770 is threaded onto the helical corrugations 716a of the outer conductor 716 until the gasket 770 is positioned adjacent to the stripped cable jacket 720. Next, the sleeve 760 is threaded onto the outer conductor 716 of the cable 710.

The connector 730 comprising the outer connector body 734, the inner contact 732, insulator 736, spring basket 733, and coupling nut 780 is then slipped over the prepared end of the cable 710. The connector 730 is slid onto the cable 710 until a shoulder 737 on the inner surface of the outer conductor body 734 contacts the prepared end 716e of the outer conductor 716 of the cable 710 and spring basket 733 engages the inner conductor 712 of the cable 710. As the connector 730 and cable 710 are engaged, the tapered section 739a on the inner surface of the tail section 739 of the connector body 734 contacts the tapered section 762a of the sleeve 760.

Once the connector 730 is positioned on the cable 710, the connector 730 may be secured to the cable 710 by crimping the tail section 739 of the outer connector body 734 onto the sleeve 760. The connector 730 and coaxial cable 710 should be held under axial force during crimping. The radial squeeze (or crimp) on the outer surface of the tail section 739 forces the tail section 739 to engage the sleeve 760. In some embodiments, a hex shape or other asymmetric crimp may be used to help prevent rotation of the cable 710 within the sleeve 760. The crimping of the outer connector body 734 of the connector 730 over the sleeve 760 provides retention and mechanical attachment. A permanent axial force is formed on the prepared end 716e of the outer conductor 716 of the cable 710 against the shoulder 737 of the connector body 734.

Once the connector 730 is crimped and secured to the cable 710, a strain relief sleeve similar to the strain relief sleeves 150-650 for the assemblies 100-600 described herein, may be slid forwardly over the connector-cable interface. The strain relief sleeve (not shown) may be advanced along the cable 710 and snapped into place on the outer connector body 734 of the connector 730, thereby forming a seal around the swaged connector-cable interface.

Referring now to FIGS. 33A-33C, an alternative coaxial cable-connector assembly 800 according to embodiments of the present invention is illustrated. Properties and/or features of the coaxial cable-connector assembly 800 may be as described above in reference to the assemblies 100-700 shown in FIGS. 1A-32, and duplicate discussion thereof may be omitted herein for the purposes of discussing FIGS. 33A-33C.

As shown in FIGS. 33A-33C, similar to the assemblies 100-700 describe above, the assembly 800 includes a coaxial cable 810 and a connector 830 attached to one end thereof. The connection interface between the connector 830 and the coaxial cable 810 may be protected by a strain relief sleeve 850. Similar to assemblies 100, 200, 500, 600, 700 described herein, the coaxial cable 810 of assembly 800 has a helical corrugated outer conductor 816. Other features of the coaxial cable 810 and connector 830 are similar to the cables and connectors described herein. As described in further detail below, the coaxial cable-connector assembly 800 illustrated in FIGS. 33A-33C differs from assemblies 100-700 described herein in the manner that the tail section 839 of the connector body 834 of the assembly 800 is configured to be secured to an alternative sleeve 860 (FIG. 34).

As shown in FIGS. 33B-33C, the assembly 800 includes both a radial O-ring 882 and an axial O-ring 883 for sealing the connector body 834. In some embodiments, the connector body 834 includes an annular recess 834a that is configured to receive the radial O-ring 882. In some embodiments, the strain relief sleeve 850 includes an annular recess or groove 850a that is configured to receive the axial O-ring 883. In some embodiments, the free end of the connector body 834 may be configured to be received by the recess 850a of the strain relief sleeve 850 and may contact the axial O-ring 883 therein. Having two different modes of sealing, i.e., radial O-ring 882 and axial O-ring 884, provides an additional layer of sealing protection because the failure modes are different. For example, if both O-rings 882, 883 were positioned side-by-side between the outer conductor body 834 and the strain relief sleeve 850, and the inner diameter of the strain relief sleeve 850 was oversized, the assembly 800 would still be susceptible to leakage (e.g., moisture, water, etc.) between the connector body 834 and the strain relief sleeve 850. However, by positioning one of the O-rings as an axial O-ring 883 which is compressed by the axial force of the end of the tail section 839 of the connector body 834 and the strain relief sleeve 850, the axial O-ring 884 helps to prevent any leakage that may have gotten past the radial O-ring 882 such as in the example of an oversized strain relief sleeve 850.

The tail section 839 of the outer conductor body 834 is configured to mate with a helical threaded sleeve 860 that circumferentially overlies the corrugated helical outer conductor 816 of the coaxial cable 810. Similar to other assemblies described herein, in some embodiments, the assembly 800 may also include a gasket 870 that circumferentially overlies the corrugated outer conductor 816 of the coaxial cable 810 and resides between the sleeve 860 and the outer jacket 820 of the cable 810. In some embodiments, the tail section 839 of the connector body 834 may comprise a first shoulder 835 and a second shoulder 837. As shown in FIG. 33C, when the connector 830 and cable 810 are engaged, an axial force drives the sleeve 860 with a press-fit into the connector body 834 (e.g., into the first shoulder 835) and against a flared end 816f of the outer conductor 816 of the cable 810 residing therebetween, i.e., creating an axial force on the flared end 816f of the outer conductor 816. At the same time, a flanged edge 864 of the sleeve 860 (see, e.g., FIG. 34) may be forced into the second shoulder 837 of the connector body 834 as the free end of the connector body 834 is received in the recess 850a of the strain relief sleeve 850 and against the axial O-ring 883.

A perspective view of the helical threaded sleeve 860 is shown in FIG. 34. In some known connector assemblies, the cable may rotate within the connector body which can lead to an increase in unwanted PIM. To mitigate this occurrence, in some embodiments, the sleeve 860 of the present invention may include one or more anti-rotation features 865. The anti-rotation features 865 are configured to engage the outer conductor 816 of the cable 810 to prohibit rotation of the cable 810 with respect to the connector body 834 through high contact pressure at edges 868e. In some embodiments, as shown in FIG. 34, the anti-rotation feature 865 may comprise a plurality of recesses 868 at one end 867 of the sleeve 860. While the recesses 868 on the end 867 of the sleeve 860 are shown to have a semi-circular or an arcuate shape in FIG. 34, the recesses 868 may have different geometries, such as knurl or rectangular slots, etc. In some embodiments, each of the recesses 868 may have one or more sharp edges 868e that are configured to engage or bite into the copper material that forms the corrugated outer conductor 816 of the cable 810, thereby helping to prevent the cable 810 from rotating within the connector body 834 and mitigating PIM. In addition, the recesses 868 help reduce the surface area along the end 867 of the sleeve 860 which allows for higher axial pressure that may be exerted by the sleeve 860 on the flare end 816f of the outer conductor 816 of the cable 810.

As shown in FIG. 33C, in some embodiments, the outer surface of the conductor body 834 of the assembly 800 may further comprise one or more barbs or other similar securing feature(s) 890 that extend outwardly therefrom. The barbs 890 are configured to engage (e.g., grip) with an inner surface of the molded strain relief sleeve 850 to help further secure the strain relief sleeve 850 to the assembly 800.

Referring now to FIGS. 35-350, an alternative coaxial cable-connector assembly 900 according to embodiments of the present invention is illustrated. Properties and/or features of the coaxial cable-connector assembly 900 may be as described above in reference to the assemblies 100-800 shown in FIGS. 1A-34, and duplicate discussion thereof may be omitted herein for the purposes of discussing FIGS. 35A-35D.

As shown in FIGS. 35A-35D, similar to the assemblies 100-800 describe above, the assembly 900 includes a coaxial cable 910 and a connector 930 attached to one end thereof. The connection interface between the connector 930 and the coaxial cable 910 may be protected by a strain relief sleeve 950. Similar to assemblies 100, 200, 500, 600, 700, 800 described herein, the coaxial cable 910 of assembly 900 has a helical corrugated outer conductor 916. Other features of the coaxial cable 910 and connector 930 are similar to the cables and connectors describe herein As described in further detail below, the coaxial cable-connector assembly 900 illustrated in FIGS. 35A-35D differs from assemblies 100-800 described herein in the assembly 900 further comprises a backing ring 938.

As shown in FIGS. 35A, 3513, and 35D, similar to assembly 800 described herein, assembly 900 may include both a radial O-ring 982 and an axial O-ring 983 for sealing the connector body 934. The tail section 939 of the outer conductor body 934 is also similar to the outer conductor 834 of assembly 800 described herein and is configured to mate with a sleeve 960 that circumferentially overlies the corrugated outer conductor 916 of the coaxial cable 910. The sleeve 960 is similar to the helical threaded sleeve 860 shown in FIG. 34. Similar to other assemblies described herein, in some embodiments, the assembly 900 may also include a gasket 970 that circumferentially overlies the corrugated outer conductor 916 of the coaxial cable 910 and resides between the sleeve 960 and the outer jacket 920 of the cable 910.

In some embodiments, and similar to the assembly 800 described herein, the outer surface of the conductor body 934 of the assembly 900 may further comprise one or more barbs or other similar securing feature(s) 990 that extend outwardly therefrom and are configured to engage (e.g., grip) with an inner surface of the molded strain relief sleeve 950 to help further secure the strain relief sleeve 950 to the assembly 900.

As shown in FIG. 35C, in some embodiments, the insulator 936 of the connector 930 may comprise a flanged end 936a. The flanged end 936a of the insulator 936 extends radially inwardly to engage a retention groove 932a of the inner contact 932 of the connector 930 which helps to secure the inner contact 932 within the connector 930.

As noted above, the assembly 900 further includes an annular backing ring 938. In some embodiments, the backing ring 938 may be formed of brass. As shown in FIG. 35B, the backing ring 938 overlies a segment of the dielectric layer 914 of the cable 910 and resides between the insulator 936 of the connector 930 and the sleeve 960. The dielectric layer 914 of the cable 910 passes through the annular backing ring 938 which may allow for electrical tuning. As shown in FIG. 35D, when the connector 930 and cable 910 are engaged, an axial force drives the sleeve 960 with a press-fit into the backing ring 938 and against a flared end 816f of the outer conductor 816 of the cable 810 residing therebetween, i.e., creating an axial force on the flared end 816f of the outer conductor 816. In some embodiments, the outer connector body 934 may be swaged or crimped onto the sleeve 960 creating a radial force driving the outer connector body 934 into the backing ring 938. At the same time, similar to assembly 800, the flanged edge of the sleeve 960 (i.e., the flanged edge 864 shown FIG. 34) may be forced into the second shoulder 937 of the connector body 934 as the free end of the connector body 934 is received by the recess 950a of the strain relief sleeve 950 and against the axial O-ring 983.

As discussed herein, a push and press-fit design could be applied to any of the assemblies 100-900 of the present invention described herein which may replace any crimp, swag, or dimple features implemented in the assembly process. In some embodiments, the push and press-fit design may not involve axial contact with the outer conductor of the connector (e.g., with respect to embodiments having radial contacts such as spring contacts). In some embodiments, the push and press-fit design may create a permanent mechanical attachment between the connector and the cable, but not necessarily the electrical contact.

Assembly of the coaxial cable-connector assemblies 100-900 of the present invention described herein is intended to reduce attachment complexity and thus labor cost, allowing the attachment to be moved from a factory setting and to a store-front type low overhead facility.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A coaxial cable-connector assembly, comprising:
(a) a coaxial cable, comprising:
an inner conductor;
a dielectric layer circumferentially surrounding the inner conductor;
a corrugated outer conductor circumferentially surrounding the dielectric layer; and
a jacket circumferentially surrounding the outer conductor;
(b) a coaxial connector, comprising:
an inner contact electrically connected with the inner conductor of the cable;
an outer connector body having a shoulder on an inner surface, the outer connector body being spaced apart from and circumferentially surrounding the inner contact;
a spring basket electrically connected with the outer conductor of the cable, wherein the spring basket is configured to mate to an inner surface of the outer conductor; and
an insulator interposed between the inner contact and the outer connector body; and
(c) a polymeric sleeve residing between the outer conductor of the cable and the outer connector body of the connector, the outer connector body swaged or crimped onto the polymeric sleeve,
wherein an end of the corrugated outer conductor is flared radially outwardly to form a flared end that secures the polymeric sleeve onto the coaxial cable,
wherein the polymeric sleeve separates the corrugated outer conductor of the coaxial cable from the outer conductor body of the coaxial connector to prevent direct radial electrical connection therebetween, and wherein the polymeric sleeve axially forces the flared end of the outer conductor of the coaxial cable into contact with the shoulder of the outer connector body of the coaxial connector.

2. The coaxial cable-connector assembly of claim 1, wherein the corrugated outer conductor has a helical configuration.

3. The coaxial cable-connector assembly of claim 1, wherein the corrugated outer conductor has an annular configuration.

4. The coaxial cable-connector assembly of claim 1, further comprising a strain relief sleeve having a tubular main body and overlying a portion of the outer connector body and a portion of the cable.

5. The coaxial cable-connector assembly of claim 1, further comprising a gasket that circumferentially overlies the corrugated outer conductor of the coaxial cable and resides between the polymeric sleeve and the outer jacket of the cable.

6. The coaxial cable-connector assembly of claim 1, wherein the polymeric sleeve and/or gasket have a corrugation fitting profile that engages one or more of the corrugations of the outer conductor.

7. The coaxial cable-connector assembly of claim 1, wherein the polymeric sleeve comprises a recess and the outer connector body is swaged or crimped onto the polymeric sleeve such that a portion of the outer connector body is deformed into the recess.

8. The coaxial cable-connector assembly of claim 1, wherein a hex shape or other asymmetric crimp is used to prevent rotation of the coaxial cable within the polymeric sleeve.

9. The coaxial cable-connector assembly of claim 1, wherein the outer connector body comprises a collet having a plurality of collet fingers with flanged edges, each of the flanged edges having a tapered surfaces, and wherein the swaging or crimping of the outer connector body forces the tapered surface of the flanged edges of the collet fingers to slide against a tapered surface of a flange extending radially outward from the polymeric sleeve to generate the axial force on the sleeve.

10. The coaxial cable-connector assembly of claim 1, wherein the outer connector body comprises a tail section having a tapered surface, and wherein the polymeric sleeve comprises a tapered surface that corresponds to the tapered surface of the tail section.

11. The coaxial cable-connector assembly of claim 1, further comprising at least two O-rings, wherein one of the O-rings radially seals the assembly and one of the O-rings axially seals the assembly.

12. The coaxial cable-connector assembly of claim 1, wherein the polymeric sleeve comprises one or more anti-rotation features.

13. The coaxial cable-connector assembly of claim 4, wherein the outer connector body comprises one or more securing features configured to engage an inner surface of the strain relief sleeve.

14.-31. (canceled)

32. A method of assembling a coaxial cable-connector assembly, the method comprising:
providing a coaxial cable having an inner conductor, a dielectric layer circumferentially surrounding the inner conductor, an outer conductor circumferentially surrounding the dielectric layer, and a jacket circumferentially surrounding the outer conductor;
providing a coaxial connector having an inner contact, an outer connector body spaced apart from and circumferentially surrounding the inner contact, a spring basket configured to mate to an inner surface of the outer conductor, and an insulator interposed between the inner contact and the outer connector body;
stripping the jacket of the cable to expose a portion of the outer conductor;
stripping the outer conductor and dielectric layer to expose the end of the inner conductor;
sliding a strain relief sleeve over the end of the cable and onto an unstripped portion of the cable jacket;
securing a gasket around the outer conductor;
securing a polymeric sleeve around the outer conductor;
flaring the end of the outer conductor radially outward;
sliding the connector onto the cable until a shoulder on an inner surface of the outer connector body contacts the flared end of the outer conductor such that the outer connector body makes electrical contact with the outer conductor of the cable, and the spring basket makes electrical contact with outer conductor of the cable such that the inner contact makes electrical contact with inner conductor of the cable;
crimping or swaging the outer connector body of the connector onto the sleeve such that the sleeve axially forces the flared end of the outer conductor in contact with the shoulder of the outer connector body; and
sliding the strain relief sleeve back toward the end of the cable to engage the connector.

33. The method of claim 32, wherein the polymeric sleeve comprises a recess and the outer connector body is swaged or crimped onto the polymeric sleeve such that a portion of the outer connector body is deformed into the recess.

34.-39. (canceled)

40. A coaxial cable-connector assembly, comprising:
(a) a coaxial cable, comprising:
an inner conductor;
a dielectric layer circumferentially surrounding the inner conductor;
a corrugated outer conductor circumferentially surrounding the dielectric layer; and
a jacket circumferentially surrounding the outer conductor;
(b) a coaxial connector, comprising:
an inner contact electrically connected with the inner conductor of the cable;
an outer connector body having a shoulder on an inner surface, the outer connector body being spaced apart from and circumferentially surrounding the inner contact; and
an insulator interposed between the inner contact and the outer connector body;
(c) a polymeric sleeve residing between the outer conductor of the cable and the outer connector body of the connector; and
(d) a backing ring circumferentially surrounding a segment of the dielectric layer on the coaxial cable and residing between the insulator of the coaxial connector and the sleeve, the backing ring making radial contact with the outer connector body,
wherein an end of the corrugated outer conductor is flared radially outwardly to form a flared end that secures the polymeric sleeve onto the coaxial cable,
wherein the polymeric sleeve separates the corrugated outer conductor of the coaxial cable from the outer conductor body of the coaxial connector to prevent direct radial electrical connection therebetween, and wherein the polymeric sleeve axially forces with a press-fit the flared end of the outer conductor of the coaxial cable into contact with the backing ring.

41. The coaxial cable-connector assembly of claim 40, further comprising a strain relief sleeve having a tubular main body and overlying a portion of the outer connector body and a portion of the cable.

42. The coaxial cable-connector assembly of claim 40, further comprising a gasket that circumferentially overlies the corrugated outer conductor of the coaxial cable and resides between the polymeric sleeve and the outer jacket of the cable.

43. The coaxial cable-connector assembly of claim 40, wherein the polymeric sleeve has a helical threaded inner surface.

44. The coaxial cable-connector assembly of claim 40, further comprising at least two O-rings, wherein one of the O-rings radially seals the assembly and one of the O-rings axially seals the assembly.
